(19) United States
(12) Patent Application Publication
(10) Pub. No.: US 2025/0071659 A1
(43) Pub. Date: Feb. 27, 2025

(54) COMMUNICATION METHOD AND COMMUNICATION APPARATUS

(71) Applicant: HUAWEI TECHNOLOGIES CO., LTD., Shenzhen (CN)

(72) Inventors: Jianbiao XU, Shenzhen (CN); Yong LIU, Shanghai (CN); Xiaoyan BI, Shanghai (CN); Huan SUN, Shenzhen (CN)

(21) Appl. No.: 18/942,916

(22) Filed: Nov. 11, 2024

Related U.S. Application Data
(63) Continuation of application No. PCT/CN2023/092932, filed on May 9, 2023.

(30) Foreign Application Priority Data
May 12, 2022 (CN) 202210512904.7

(51) Int. Cl. H04W 40/24; H04B 7/04; H04W 72/1268; H04W 72/21

(52) U.S. Cl. CPC H04W 40/246; H04W 72/1268; H04W 72/21; H04B 7/04013

(57) ABSTRACT

This application provides a communication method and a communication apparatus. The method includes: A terminal device obtains first indication information and downlink channel information, where the first indication information indicates a first path domain parameter, the first path domain parameter is a path domain parameter shared by a first uplink channel and a first downlink channel, and the first uplink channel and the first downlink channel are channels for communication between a network device and the terminal device. The terminal device estimates a second path domain parameter based on the first path domain parameter and the downlink channel information, and sends the second path domain parameter to the network device. The first path domain parameter and the second path domain parameter are used by the network device to reconstruct the first downlink channel.

### CROSS-REFERENCE TO RELATED APPLICATIONS

This application is a continuation of International Application No. PCT/CN2023/092932, filed on May 9, 2023, which claims priority to Chinese Patent Application No. 202210512904.7, filed on May 12, 2022. The disclosures of the aforementioned applications are hereby incorporated by reference in their entireties.

### TECHNICAL FIELD

This application relates to the communication field, and more specifically, to a communication method and a communication apparatus in the communication field.

### BACKGROUND

Multiple-input multiple-output (multiple-input multiple-output, MIMO) is an important technology for improving a system capacity and spectral efficiency in a wireless communication system. In the existing MIMO technology, for a scenario (for example, an FDD system) in which uplink and downlink channels are not reciprocal, a typical channel sounding method is as follows: A base station (base station, BS) transmits downlink pilot signals whose quantity is equal to a quantity of antennas or logical ports of the base station to a terminal device. The terminal device estimates downlink channel state information (channel state information, CSI) based on the downlink pilot signals, quantizes the downlink CSI, and feeds back quantized downlink CSI to the BS. The BS performs downlink precoding based on the quantized downlink CSI fed back by the terminal device. However, a large quantity of antennas or logical ports of the BS are usually used in the MIMO technology, resulting in high corresponding downlink pilot overheads and uplink feedback overheads. How to reduce downlink pilot overheads and uplink feedback overheads in the MIMO technology has become a bottleneck problem.

### SUMMARY

Embodiments of this application provide a communication method and a communication apparatus, to reduce downlink pilot overheads and uplink feedback overheads.

According to a first aspect, a communication method is provided. The method includes: A terminal device obtains first indication information, and obtains downlink channel information, where the first indication information indicates a first path domain parameter, the first path domain parameter is a path domain parameter shared by a first uplink channel and a first downlink channel, the first uplink channel and the first downlink channel are channels for communication between a network device and the terminal device, the downlink channel information is sent through M antenna ports in N antenna ports of the network device, 1≤M<N, and both M and N are positive integers. The terminal device estimates a second path domain parameter based on the first path domain parameter and the downlink channel information. The terminal device sends second indication information, where the second indication information indicates the second path domain parameter, and the first path domain parameter and the second path domain parameter are used for channel reconstruction of the first downlink channel.

Specifically, the antenna port may also be referred to as an antenna unit.

By way of example, and not limitation, the first indication information and the second indication information may indicate the first path domain parameter and the second path domain parameter by using a mapping table, or may indicate the first path domain parameter and the second path domain parameter by using an index.

In this embodiment of this application, the terminal device obtains downlink channel information delivered by some antenna ports of the network device, estimates, with reference to a path domain parameter that is shared by an uplink channel and a downlink channel and that is provided by the network device, a path domain parameter not shared by the downlink channel and the uplink channel, and feeds back the path domain parameter not shared by the downlink channel and the uplink channel to the network device. According to this embodiment of this application, downlink signaling overheads and uplink feedback signaling overheads can be reduced.

With reference to the first aspect, in some implementations of the first aspect, the first path domain parameter includes at least one of a power coefficient, a direction angle, and a Doppler factor that are of the first uplink channel.

It should be understood that the power coefficient, the direction angle, and the Doppler factor that are of the first uplink channel are path domain parameters that can be shared by the first uplink channel and the first downlink channel between the network device and the terminal device. In addition, when the first uplink channel has a plurality of paths, each path has a corresponding power coefficient, direction angle, and Doppler factor.

The network device in this embodiment of this application can estimate specific values of the power coefficient, the direction angle, and the Doppler factor that are of the first uplink channel based on methods such as MLE, MAP, and SBL, so that accuracy of estimating the second path domain parameter by the terminal device can be improved.

With reference to the first aspect, in some implementations of the first aspect, the second path domain parameter includes an initial phase of the first downlink channel.

It should be understood that the initial phase of the first downlink channel is a path domain parameter that cannot be shared by the first uplink channel and the first downlink channel between the network device and the terminal device. In addition, when the first downlink channel has a plurality of paths, each path has a corresponding initial phase value.

With reference to the first aspect, in some implementations of the first aspect, before the terminal device obtains the first indication information, the method further includes: The terminal device sends uplink channel information, where the first indication information is determined based on the uplink channel information.

The terminal device sends the uplink channel information to the network device, and the terminal device sends, the uplink channel information whose quantity is equal to a quantity of antenna ports (which may be simply one port) of the terminal device to the network device, so that signaling overheads can be reduced.

With reference to the first aspect, in some implementations of the first aspect, that the first indication information is determined based on the uplink channel information further includes: The terminal device sends first parameter information, where the first parameter information indicates a parameter of an antenna array of the terminal device, the first indication information is generated based on the uplink channel information, the first parameter information, and second parameter information, and the second parameter information indicates a parameter of an antenna array of the network device.

The terminal device sends the parameter of the antenna array of the terminal device to the network device, so that when estimating the first path domain parameter, the network device may refer to the parameter of the antenna array of the terminal device and the parameter of the antenna array of the network device, to obtain a more accurate first path domain parameter.

With reference to the first aspect, in some implementations of the first aspect, the parameter of the antenna array includes at least one of a topology form, an element spacing, an element pattern, and a polarization form that are of the antenna array.

Specifically, the first parameter information includes at least one of a topology form, an element spacing, an element pattern, and a polarization form that are of the antenna array of the terminal device; and the second parameter information includes at least one of a topology form, an element spacing, an element pattern, and a polarization form that are of the antenna array of the network device.

The topology form of the antenna array may be a linear array topology, a planar array topology, a circular array topology, or the like of the antenna array.

When the network device estimates the first path domain parameter based on the parameter of the antenna array of the terminal device and the parameter of the antenna array of the network device, more reference information included in the parameter of the antenna array indicates that a more accurate first path domain parameter can be obtained.

With reference to the first aspect, in some implementations of the first aspect, before the terminal device estimates the second path domain parameter based on the first path domain parameter and the downlink channel information, the method further includes: The terminal device obtains the second parameter information, and the terminal device estimates the second path domain parameter based on the first path domain parameter, the downlink channel information, the first parameter information, and the second parameter information.

When estimating the second path domain parameter, the terminal device may refer to the parameter of the antenna array of the terminal device and the parameter of the antenna array of the network device, to obtain a more accurate second path domain parameter.

With reference to the first aspect, in some implementations of the first aspect, the method further includes: The terminal device obtains third indication information, where the third indication information indicates a reflection coefficient of a reconfigurable intelligent surface RIS array, and the RIS array is used to reflect a signal between the terminal device and the network device.

The terminal device may obtain the reflection coefficient of the RIS array by using signaling, and may further obtain more accurate downlink channel information with reference to the reflection coefficient of the RIS array.

With reference to the first aspect, in some implementations of the first aspect, the first indication information further indicates the first path domain parameter, a third path domain parameter, and a fifth path domain parameter, the third path domain parameter is a path domain parameter shared by a second uplink channel and a second downlink channel, the second uplink channel and the second downlink channel are channels for communication between the network device and the RIS array, the fifth path domain parameter is a path domain parameter shared by a third uplink channel and a third downlink channel, and the third uplink channel and the third downlink channel are channels for communication between the RIS array and the terminal device.

The network device can not only indicate the first path domain parameter of the direct channel between the network device and the terminal device to the terminal device, but also indicate the third path domain parameter and the fifth path domain parameter of the reflection channel between the network device and the RIS array and between the RIS array and the terminal device to the terminal device, so that the terminal device separately estimates, based on a path domain parameter shared by each uplink channel and each downlink channel, a path domain parameter that is of the downlink channel and not shared by the uplink channel and the downlink channel.

With reference to the first aspect, in some implementations of the first aspect, the second indication information further indicates the second path domain parameter, a fourth path domain parameter, and a sixth path domain parameter, the fourth path domain parameter is determined by the terminal device based on the third path domain parameter and the downlink channel information, and the sixth path domain parameter is determined by the terminal device based on the fifth path domain parameter and the downlink channel information.

It should be understood that the fourth path domain parameter is a path domain parameter not shared by the second downlink channel and the second uplink channel between the network device and the RIS array. Similarly, the sixth path domain parameter is a path domain parameter not shared by the third downlink channel and the third uplink channel between the RIS array and the terminal device.

With reference to the first aspect, in some implementations of the first aspect, that the fourth path domain parameter is determined by the terminal device based on the third path domain parameter and the downlink channel information further includes: the fourth path domain parameter is determined by the terminal device based on the third path domain parameter, the downlink channel information, and the reflection coefficient of the RIS array; and that the sixth path domain parameter is determined by the terminal device based on the fifth path domain parameter and the downlink channel information further includes: the sixth path domain parameter is determined by the terminal device based on the fifth path domain parameter, the downlink channel information, and the reflection coefficient of the RIS array.

When estimating the fourth path domain parameter and the sixth path domain parameter, the terminal device may obtain a more accurate estimated value based on the reflection coefficient of the RIS array.

According to a second aspect, a communication method is provided. The method includes: A network device obtains uplink channel information; the network device estimates a first path domain parameter based on the uplink channel information, where the first path domain parameter is a path domain parameter shared by a first uplink channel and a first downlink channel, and the first uplink channel and the first downlink channel are channels for communication between the network device and a terminal device; the network device sends first indication information, and sends downlink channel information through M antenna ports in N antenna ports of the network device, where the first indication information indicates the first path domain parameter, 1≤M<N, and both M and N are positive integers; the network device obtains second indication information, where the second indication information indicates a second path domain parameter, and the second path domain parameter is determined based on the first path domain parameter and the downlink channel information; and the network device performs channel reconstruction on the first downlink channel based on the first path domain parameter and the second path domain parameter.

Specifically, the antenna port may also be referred to as an antenna unit.

By way of example, and not limitation, the first indication information and the second indication information may indicate the first path domain parameter and the second path domain parameter by using a mapping table, or may indicate the first path domain parameter and the second path domain parameter by using an index.

In this embodiment of this application, the network device sends the downlink channel information on some antenna ports of all antenna ports of the network device by using the estimated path domain parameter shared by the uplink channel and the downlink channel as a reference, so that downlink signaling overheads can be reduced. In addition, the network device obtains a feedback on a path domain parameter of the downlink channel from the terminal device, so that uplink feedback signaling overheads can be reduced.

With reference to the second aspect, in some implementations of the second aspect, the first path domain parameter includes at least one of a power coefficient, a direction angle, and a Doppler factor that are of the first uplink channel.

It should be understood that the power coefficient, the direction angle, and the Doppler factor that are of the first uplink channel are path domain parameters that can be shared by the first uplink channel and the first downlink channel between the network device and the terminal device. In addition, when the first uplink channel has a plurality of paths, each path has a corresponding power coefficient, direction angle, and Doppler factor.

The network device in this embodiment of this application can estimate specific values of the power coefficient, the direction angle, and the Doppler factor that are of the first uplink channel by using methods such as maximum likelihood estimation (maximum likelihood estimation, MLE), maximum a posteriori (maximum a posteriori, MAP), and sparse Bayesian learning (sparse Bayesian learning, SBL) that are based on the Bayesian criterion, to improve accuracy of reconstructing a first downlink channel information matrix.

With reference to the second aspect, in some implementations of the second aspect, the second path domain parameter includes an initial phase of the first downlink channel.

It should be understood that the initial phase of the first downlink channel is a path domain parameter that cannot be shared by the first uplink channel and the first downlink channel between the network device and the terminal device. In addition, when the first downlink channel has a plurality of paths, each path has a corresponding initial phase value.

With reference to the second aspect, in some implementations of the second aspect, that the network device estimates a first path domain parameter based on the uplink channel information further includes: The network device obtains first parameter information, where the first parameter information indicates a parameter of an antenna array of the terminal device; and the network device estimates the first path domain parameter based on the uplink channel information, second parameter information, and the first parameter information, where the second parameter information indicates a parameter of an antenna array of the network device.

When estimating the first path domain parameter, the network device obtains a more accurate first path domain parameter based on the parameter of the antenna array of the terminal device and the parameter of the antenna array of the network device.

With reference to the second aspect, in some implementations of the second aspect, the parameter of the antenna array includes at least one of a topology form, an element spacing, an element pattern, and a polarization form that are of the antenna array.

Specifically, the first parameter information includes at least one of a topology form, an element spacing, an element pattern, and a polarization form that are of the antenna array of the terminal device; and the second parameter information includes at least one of a topology form, an element spacing, an element pattern, and a polarization form that are of the antenna array of the network device.

The topology form of the antenna array may be a linear array topology, a planar array topology, a circular array topology, or the like of the antenna array.

When the network device estimates the first path domain parameter based on the parameter of the antenna array of the terminal device and the parameter of the antenna array of the network device, more reference information included in the parameter of the antenna array indicates that a more accurate first path domain parameter can be obtained.

With reference to the second aspect, in some implementations of the second aspect, the method further includes: The network device obtains third parameter information, where the third parameter information indicates an antenna array parameter of a reconfigurable intelligent surface RIS array; and the network device sends third indication information based on the third parameter information, where the third indication information indicates a reflection coefficient of the RIS array, and the RIS array is used to reflect a signal between the network device and the terminal device.

After obtaining the antenna array parameter of the RIS array, the network device may set a proper RIS array reflection coefficient for the RIS array. When the RIS array reflects a signal between the network device and the terminal device, the network device or the terminal device may estimate a channel path domain parameter between the RIS array and the network device or between the RIS array and the terminal device.

With reference to the second aspect, in some implementations of the second aspect, the method further includes: The network device estimates the first path domain parameter, a third path domain parameter, and a fifth path domain parameter based on the uplink channel information, where the third path domain parameter is a path domain parameter shared by a second uplink channel and a second downlink channel, the second uplink channel and the second downlink channel are channels for communication between the network device and the RIS array, the fifth path domain parameter is a path domain parameter shared by a third uplink channel and a third downlink channel, and the third uplink channel and the third downlink channel are channels for communication between the RIS array and the terminal device.

The network device can not only estimate the path domain parameter shared by the first uplink channel and the first downlink channel based on the methods such as MLE, MAP, and SBL, but also estimate the path domain parameter shared by the second uplink channel and the second downlink channel between the network device and the RIS array based on the methods such as MLE, MAP, and SBL, and estimate the path domain parameter shared by the third uplink channel and the third downlink channel between the RIS array and the terminal device.

With reference to the second aspect, in some implementations of the second aspect, the first indication information further indicates the first path domain parameter, the third path domain parameter, and the fifth path domain parameter.

The network device indicates, to the terminal device, the path domain parameter shared by the uplink channel and the downlink channel between the network device and the terminal device, between the network device and the RIS array, or between the RIS array and the terminal device, so that the terminal device can estimate a specific path domain parameter of each downlink channel based on a path domain parameter shared by each uplink channel and each downlink channel.

With reference to the second aspect, in some implementations of the second aspect, that the network device estimates the first path domain parameter, a third path domain parameter, and a fifth path domain parameter based on the uplink channel information further includes: The network device estimates the first path domain parameter, the third path domain parameter, and the fifth path domain parameter based on the uplink channel information, the first parameter information, the second parameter information, the third parameter information, and the reflection coefficient of the RIS array.

When estimating the path domain parameters shared by the uplink channels and the downlink channels between the network device and the terminal device, between the network device and the RIS array, and between the RIS array and the terminal device, the network device obtains a more accurate first path domain parameter, third path domain parameter, and fifth path domain parameter based on the parameter of the antenna array of the terminal device, the parameter of the antenna array of the network device, the antenna array parameter of the RIS array, and the reflection coefficient of the RIS array.

With reference to the second aspect, in some implementations of the second aspect, the second indication information further indicates the second path domain parameter, a fourth path domain parameter, and a sixth path domain parameter, the fourth path domain parameter is determined based on the third path domain parameter and the downlink channel information, and the sixth path domain parameter is determined based on the fifth path domain parameter and the downlink channel information.

It should be understood that the fourth path domain parameter is a path domain parameter not shared by the second downlink channel and the second uplink channel between the network device and the RIS array. Similarly, the sixth path domain parameter is a path domain parameter not shared by the third downlink channel and the third uplink channel between the RIS array and the terminal device.

With reference to the second aspect, in some implementations of the second aspect, that the network device performs channel reconstruction on the first downlink channel based on the first path domain parameter and the second path domain parameter further includes: The network device performs channel reconstruction on the second downlink channel based on the third path domain parameter and the fourth path domain parameter; and the network device performs channel reconstruction on the third downlink channel based on the fifth path domain parameter and the sixth path domain parameter.

With reference to the second aspect, in some implementations of the second aspect, before the network device obtains the uplink channel information, or before the network device sends the downlink channel information, the method further includes: The network device sends fourth indication information to the RIS array, where the fourth indication information indicates the RIS array to disable a signal reflection function.

With reference to the second aspect, in some implementations of the second aspect, after the network device estimates the first path domain parameter, or after the network device obtains the second indication information that indicates the second path domain parameter, the method further includes: The network device sends fifth indication information to the RIS array, where the fifth indication information indicates the RIS array to enable the signal reflection function.

The network device indicates the RIS array to disable or enable the signal reflection function, to decouple sounding of an uplink channel and a downlink channel of a direct channel between the network device and the terminal device or a reflection channel between the network device and the RIS array or between the RIS array and the terminal device, to improve precision of channel sounding.

According to a third aspect, a communication apparatus is provided. The apparatus includes: a communication unit, configured to: obtain first indication information, and obtain downlink channel information, where the first indication information indicates a first path domain parameter, the first path domain parameter is a path domain parameter shared by a first uplink channel and a first downlink channel, the first uplink channel and the first downlink channel are channels for communication between a network device and a terminal device, the downlink channel information is sent through M antenna ports in N antenna ports of the network device, 1≤M<N, and both M and N are positive integers; and a processing unit, configured to estimate a second path domain parameter based on the first path domain parameter and the downlink channel information; and the communication unit is further configured to send second indication information, where the second indication information indicates the second path domain parameter, and the first path domain parameter and the second path domain parameter are used for channel reconstruction of the first downlink channel.

Specifically, the antenna port may also be referred to as an antenna unit.

By way of example, and not limitation, the first indication information and the second indication information may indicate the first path domain parameter and the second path domain parameter by using a mapping table, or may indicate the first path domain parameter and the second path domain parameter by using an index.

In this embodiment of this application, downlink channel information delivered by some antenna ports of the network device is obtained. With reference to a path domain parameter that is shared by an uplink channel and a downlink channel and that is provided by the network device, a path domain parameter not shared by the downlink channel and the uplink channel can be estimated. The path domain parameter not shared by the downlink channel and the uplink channel is fed back to the network device. According to this embodiment of this application, downlink signaling overheads and uplink feedback signaling overheads can be reduced.

With reference to the third aspect, in some implementations of the third aspect, the first path domain parameter includes at least one of a power coefficient, a direction angle, and a Doppler factor that are of the first uplink channel.

It should be understood that the power coefficient, the direction angle, and the Doppler factor that are of the first uplink channel are path domain parameters that can be shared by the first uplink channel and the first downlink channel between the network device and the terminal device. In addition, when the first uplink channel has a plurality of paths, each path has a corresponding power coefficient, direction angle, and Doppler factor.

According to this embodiment of this application, estimate specific values of the power coefficient, the direction angle, and the Doppler factor that are of the first uplink channel can be estimated based on methods such as MLE, MAP, and SBL, so that accuracy of estimating the second path domain parameter can be improved.

With reference to the third aspect, in some implementations of the third aspect, the second path domain parameter includes an initial phase of the first downlink channel.

It should be understood that the initial phase of the first downlink channel is a path domain parameter that cannot be shared by the first uplink channel and the first downlink channel between the network device and the terminal device. In addition, when the first downlink channel has a plurality of paths, each path has a corresponding initial phase value.

With reference to the third aspect, in some implementations of the third aspect, before the communication unit is configured to obtain the first indication information, the communication unit is further configured to send uplink channel information, where the first indication information is determined based on the uplink channel information.

The terminal device sends the uplink channel information whose quantity is equal to a quantity of antenna ports (which may be simply one port) of the terminal device to the network device, so that signaling overheads can be reduced.

With reference to the third aspect, in some implementations of the third aspect, that the first indication information is determined based on the uplink channel information includes: The communication unit is further configured to send first parameter information, where the first parameter information indicates a parameter of an antenna array of the terminal device, the first indication information is generated based on the uplink channel information, the first parameter information, and second parameter information, and the second parameter information indicates a parameter of an antenna array of the network device.

The terminal device sends the parameter of the antenna array of the terminal device to the network device, so that when estimating the first path domain parameter, the network device may refer to the parameter of the antenna array of the terminal device and the parameter of the antenna array of the network device, to obtain a more accurate first path domain parameter.

With reference to the third aspect, in some implementations of the third aspect, the parameter of the antenna array includes at least one of a topology form, an element spacing, an element pattern, and a polarization form that are of the antenna array.

Specifically, the first parameter information includes at least one of a topology form, an element spacing, an element pattern, and a polarization form that are of the antenna array of the terminal device; and the second parameter information includes at least one of a topology form, an element spacing, an element pattern, and a polarization form that are of the antenna array of the network device.

The topology form of the antenna array may be a linear array topology, a planar array topology, a circular array topology, or the like of the antenna array.

More reference information included in the antenna array parameter indicates a more accurate first path domain parameter and second path domain parameter.

With reference to the third aspect, in some implementations of the third aspect, that the processing unit is configured to estimate a second path domain parameter based on the first path domain parameter and the downlink channel information further includes: The communication unit is further configured to obtain the second parameter information, and the processing unit is further configured to estimate the second path domain parameter based on the first path domain parameter, the downlink channel information, the first parameter information, and the second parameter information.

For estimation of the second path domain parameter, refer to the parameter of the antenna array of the terminal device and the parameter of the antenna array of the network device, to obtain a more accurate second path domain parameter.

With reference to the third aspect, in some implementations of the third aspect, the communication unit is further configured to obtain third indication information, where the third indication information indicates a reflection coefficient of a reconfigurable intelligent surface RIS array, and the RIS array is used to reflect a signal between the terminal device and the network device.

The terminal device may obtain the reflection coefficient of the RIS array by using signaling, and may further obtain more accurate downlink channel information with reference to the reflection coefficient of the RIS array.

With reference to the third aspect, in some implementations of the third aspect, the first indication information further indicates the first path domain parameter, a third path domain parameter, and a fifth path domain parameter, the third path domain parameter is a path domain parameter shared by a second uplink channel and a second downlink channel, the second uplink channel and the second downlink channel are channels for communication between the network device and the RIS array, the fifth path domain parameter is a path domain parameter shared by a third uplink channel and a third downlink channel, and the third uplink channel and the third downlink channel are channels for communication between the RIS array and the terminal device.

In the foregoing technical solution, not only the first path domain parameter of the direct channel between the network device and the terminal device can be indicated to the terminal device, but also the third path domain parameter and the fifth path domain parameter of the reflection channel between the network device and the RIS array and between the RIS array and the terminal device can be indicated to the terminal device, so that the terminal device separately estimates, based on a path domain parameter shared by each uplink channel and each downlink channel, a path domain parameter that is of the downlink channel and not shared by the uplink channel and the downlink channel.

With reference to the third aspect, in some implementations of the third aspect, the second indication information further indicates the second path domain parameter, a fourth path domain parameter, and a sixth path domain parameter, the fourth path domain parameter is determined based on the third path domain parameter and the downlink channel information, and the sixth path domain parameter is determined based on the fifth path domain parameter and the downlink channel information.

It should be understood that the fourth path domain parameter is a path domain parameter not shared by the second downlink channel and the second uplink channel between the network device and the RIS array. Similarly, the sixth path domain parameter is a path domain parameter not shared by the third downlink channel and the third uplink channel between the RIS array and the terminal device.

With reference to the third aspect, in some implementations of the third aspect, that the fourth path domain parameter is determined by the terminal device based on the third path domain parameter and the downlink channel information further includes: the fourth path domain parameter is determined by the terminal device based on the third path domain parameter, the downlink channel information, and the reflection coefficient of the RIS array; and that the sixth path domain parameter is determined by the terminal device based on the fifth path domain parameter and the downlink channel information further includes: the sixth path domain parameter is determined by the terminal device based on the fifth path domain parameter, the downlink channel information, and the reflection coefficient of the RIS array.

For estimation of the fourth path domain parameter and the sixth path domain parameter, a more accurate estimated value can be obtained based on the reflection coefficient of the RIS array.

According to a fourth aspect, a communication apparatus is provided. The apparatus includes: a communication unit, configured to obtain uplink channel information; and a processing unit, configured to estimate a first path domain parameter based on the uplink channel information, where the first path domain parameter is a path domain parameter shared by a first uplink channel and a first downlink channel, and the first uplink channel and the first downlink channel are channels for communication between a network device and a terminal device; the communication unit is further configured to send first indication information, and send downlink channel information through M antenna ports in N antenna ports of the network device, where the first indication information indicates the first path domain parameter, 1≤M<N, and both M and N are positive integers; the communication unit is further configured to obtain second indication information, where the second indication information indicates a second path domain parameter, and the second path domain parameter is determined based on the first path domain parameter and the downlink channel information; and the processing unit is further configured to perform channel reconstruction on the first downlink channel based on the first path domain parameter and the second path domain parameter.

Specifically, the antenna port may also be referred to as an antenna unit.

By way of example, and not limitation, the first indication information and the second indication information may indicate the first path domain parameter and the second path domain parameter by using a mapping table, or may indicate the first path domain parameter and the second path domain parameter by using an index.

In this embodiment of this application, the downlink channel information is sent on some antenna ports of all antenna ports of the network device by using the estimated path domain parameter shared by the uplink channel and the downlink channel as a reference, so that downlink signaling overheads can be reduced. In addition, path domain parameters of the downlink channel that are fed back by the terminal device to the network device can also be reduced.

With reference to the fourth aspect, in some implementations of the fourth aspect, the first path domain parameter includes at least one of a power coefficient, a direction angle, and a Doppler factor that are of the first uplink channel.

It should be understood that the power coefficient, the direction angle, and the Doppler factor that are of the first uplink channel are path domain parameters that can be shared by the first uplink channel and the first downlink channel between the network device and the terminal device. In addition, when the first uplink channel has a plurality of paths, each path has a corresponding power coefficient, direction angle, and Doppler factor.

The network device in this embodiment of this application can estimate specific values of the power coefficient, the direction angle, and the Doppler factor that are of the first uplink channel based on methods such as MLE, MAP, and SBL, so that accuracy of reconstructing a first downlink channel information matrix can be improved.

With reference to the fourth aspect, in some implementations of the fourth aspect, the second path domain parameter includes an initial phase of the first downlink channel.

It should be understood that the initial phase of the first downlink channel is a path domain parameter that cannot be shared by the first uplink channel and the first downlink channel between the network device and the terminal device. In addition, when the first downlink channel has a plurality of paths, each path has a corresponding initial phase value.

With reference to the fourth aspect, in some implementations of the fourth aspect, the communication unit is further configured to obtain first parameter information, where the first parameter information indicates a parameter of an antenna array of the terminal device; and the processing unit is further configured to estimate the first path domain parameter based on the uplink channel information, second parameter information, and the first parameter information, where the second parameter information indicates a parameter of an antenna array of the network device.

A more accurate first path domain parameter can be obtained based on the parameter of the antenna array of the terminal device and the parameter of the antenna array of the network device.

With reference to the fourth aspect, in some implementations of the fourth aspect, the parameter of the antenna array includes at least one of a topology form, an element spacing, an element pattern, and a polarization form that are of the antenna array.

Specifically, the first parameter information includes at least one of a topology form, an element spacing, an element pattern, and a polarization form that are of the antenna array of the terminal device; and the second parameter information includes at least one of a topology form, an element spacing, an element pattern, and a polarization form that are of the antenna array of the network device.

The topology form of the antenna array may be a linear array topology, a planar array topology, a circular array topology, or the like of the antenna array.

During estimation of the first path domain parameter based on the parameter of the antenna array of the terminal device and the parameter of the antenna array of the network device, more reference information included in the parameter of the antenna array indicates that a more accurate first path domain parameter can be obtained.

With reference to the fourth aspect, in some implementations of the fourth aspect, the communication unit is further configured to obtain third parameter information, where the third parameter information indicates a parameter of an antenna array of a reconfigurable intelligent surface RIS array; and the communication unit is configured to send third indication information based on the third parameter information, where the third indication information indicates a reflection coefficient of the RIS array, and the RIS array is used to reflect a signal between the network device and the terminal device.

After obtaining the antenna array parameter of the RIS array, the network device may set a proper RIS array reflection coefficient for the RIS array. When the RIS array reflects a signal between the network device and the terminal device, the processing unit may estimate a channel path domain parameter between the RIS array and the network device or between the RIS array and the terminal device.

With reference to the fourth aspect, in some implementations of the fourth aspect, the processing unit is further configured to estimate the first path domain parameter, a third path domain parameter, and a fifth path domain parameter based on the uplink channel information, where the third path domain parameter is a path domain parameter shared by a second uplink channel and a second downlink channel, the second uplink channel and the second downlink channel are channels for communication between the network device and the RIS array, the fifth path domain parameter is a path domain parameter shared by a third uplink channel and a third downlink channel, and the third uplink channel and the third downlink channel are channels for communication between the RIS array and the terminal device.

The network device can not only estimate the path domain parameter shared by the first uplink channel and the first downlink channel based on the methods such as MLE, MAP, and SBL, but also estimate the path domain parameter shared by the second uplink channel and the second downlink channel between the network device and the RIS array based on the methods such as MLE, MAP, and SBL, and estimate the path domain parameter shared by the third uplink channel and the third downlink channel between the RIS array and the terminal device.

With reference to the fourth aspect, in some implementations of the fourth aspect, the first indication information further indicates the first path domain parameter, the third path domain parameter, and the fifth path domain parameter.

The path domain parameter shared by the uplink channel and the downlink channel between the network device and the terminal device, between the network device and the RIS array, or between the RIS array and the terminal device is indicated to the processing unit, so that the processing unit can estimate a specific path domain parameter of each downlink channel based on a path domain parameter shared by each uplink channel and each downlink channel.

With reference to the fourth aspect, in some implementations of the fourth aspect, that the processing unit is further configured to estimate the first path domain parameter, a third path domain parameter, and a fifth path domain parameter based on the uplink channel information includes: The processing unit is further configured to estimate the first path domain parameter, the third path domain parameter, and the fifth path domain parameter based on the uplink channel information, the first parameter information, the second parameter information, the third parameter information, and the reflection coefficient of the RIS array.

A more accurate first path domain parameter, third path domain parameter, and fifth path domain parameter can be obtained based on the parameter of the antenna array of the terminal device, the parameter of the antenna array of the network device, the antenna array parameter of the RIS array, and the reflection coefficient of the RIS array.

With reference to the fourth aspect, in some implementations of the fourth aspect, the second indication information further indicates the second path domain parameter, a fourth path domain parameter, and a sixth path domain parameter, the fourth path domain parameter is determined based on the third path domain parameter and the downlink channel information, and the sixth path domain parameter is determined based on the fifth path domain parameter and the downlink channel information.

It should be understood that the fourth path domain parameter is a path domain parameter not shared by the second downlink channel and the second uplink channel between the network device and the RIS array. Similarly, the sixth path domain parameter is a path domain parameter not shared by the third downlink channel and the third uplink channel between the RIS array and the terminal device.

With reference to the fourth aspect, in some implementations of the fourth aspect, the processing unit is further configured to perform channel reconstruction on the second downlink channel based on the third path domain parameter and the fourth path domain parameter; and the processing unit is further configured to perform channel reconstruction on the third downlink channel based on the fifth path domain parameter and the sixth path domain parameter.

With reference to the fourth aspect, in some implementations of the fourth aspect, before the communication unit is configured to obtain the uplink channel information, or before the communication unit is configured to send the downlink channel information, the communication unit is further configured to send fourth indication information to the RIS array, where the fourth indication information indicates the RIS array to disable a signal reflection function.

With reference to the fourth aspect, in some implementations of the fourth aspect, after the processing unit is configured to estimate the first path domain parameter, or after the communication unit is configured to obtain the second indication information that indicates the second path domain parameter, the communication unit is further configured to send fifth indication information to the RIS array, where the fifth indication information indicates the RIS array to enable the signal reflection function.

The RIS array is indicated to disable or enable the signal reflection function, to decouple sounding of an uplink channel and a downlink channel of a direct channel between the network device and the terminal device or a reflection channel between the network device and the RIS array or between the RIS array and the terminal device, to improve precision of channel sounding.

According to a fifth aspect, a communication apparatus is provided. The apparatus may be a terminal device, or may be a component (for example, a processor, a chip, or a chip system) of a terminal device, or may be a logical module or software that can implement all or some functions of a terminal device. The apparatus has a function of implementing the first aspect and the possible implementations. The function may be implemented by hardware, or may be implemented by hardware executing corresponding software. The hardware or the software includes one or more modules corresponding to the function.

In a possible design, the apparatus includes a communication unit and a processing unit. The communication unit may be at least one of a transceiver, a receiver, and a transmitter. The communication unit may include a radio frequency circuit or an antenna. The processing unit may be a processor. Optionally, the apparatus further includes a storage unit, and the storage unit may be, for example, a memory. When the apparatus includes a storage unit, the storage unit is configured to store a program or instructions. The processing unit is connected to the storage unit, and the processing unit may execute the program or the instructions stored in the storage unit, or instructions from another source, so that the apparatus performs the communication method in the first aspect and the possible implementations. In this design, the apparatus may be a terminal device.

In another possible design, when the apparatus is a chip, the chip includes a communication unit and a processing unit. The communication unit may be, for example, an input/output interface, a pin, or a circuit on the chip. The processing unit may be, for example, a processor. The processing unit may execute instructions, to enable the chip in the network device to perform the communication method according to the first aspect and the possible implementations. Optionally, the processing unit may execute instructions in a storage unit, and the storage unit may be a storage module, for example, a register or a cache, in the chip. The storage unit may alternatively be located inside a communication device but outside the chip, for example, a read-only memory (read-only memory, ROM) or another type of static storage device that can store static information and instructions, or a random access memory (random access memory, RAM).

The processor mentioned anywhere above may be a general-purpose central processing unit (CPU), a microprocessor, an application-specific integrated circuit (application-specific integrated circuit, ASIC), or one or more integrated circuits configured to control program execution of the communication methods according to the foregoing aspects.

According to a sixth aspect, a communication apparatus is provided. The apparatus may be a network device, or may be a component (for example, a processor, a chip, or a chip system) of a network device, or may be a logical module or software that can implement all or some functions of a network device. The apparatus has a function of implementing the second aspect and the possible implementations. The function may be implemented by hardware, or may be implemented by hardware executing corresponding software. The hardware or the software includes one or more modules corresponding to the function.

In a possible design, the apparatus includes a communication unit and a processing unit. The communication unit may be, for example, at least one of a transceiver, a receiver, and a transmitter. The communication unit may include a radio frequency circuit or an antenna. The processing unit may be a processor.

Optionally, the apparatus further includes a storage unit, and the storage unit may be, for example, a memory. When the apparatus includes a storage unit, the storage unit is configured to store a program or instructions. The processing unit is connected to the storage unit, and the processing unit may execute the program or the instructions stored in the storage unit, or instructions from another source, so that the apparatus performs the method in the second aspect or any implementation of the second aspect.

In another possible design, when the apparatus is a chip, the chip includes a communication unit and a processing unit. The communication unit may be, for example, an input/output interface, a pin, or a circuit on the chip. The processing unit may be, for example, a processor. The processing module may execute a program or instructions, to enable the chip in the terminal device to perform the communication method in the second aspect and the possible implementations.

Optionally, the processing unit may execute instructions in a storage unit, and the storage unit may be a storage module, for example, a register or a cache, in the chip. The storage unit may alternatively be located inside a communication device but outside the chip, for example, a read-only memory (read-only memory, ROM) or another type of static storage device that can store static information and instructions, or a random access memory (random access memory, RAM).

The processor mentioned anywhere above may be a general-purpose central processing unit (CPU), a microprocessor, an application-specific integrated circuit (application-specific integrated circuit, ASIC), or one or more integrated circuits configured to control program execution of the communication methods according to the foregoing aspects.

According to a seventh aspect, a computer storage medium is provided. The computer storage medium stores program code. The program code indicates instructions for performing the method in the first aspect, the second aspect, and the possible implementations of the first aspect and the second aspect.

According to an eighth aspect, a computer program product including computer instructions or computer code is provided. When the computer program product is run on a computer, the computer is enabled to perform the method in the first aspect, the second aspect, and the possible implementations of the first aspect and the second aspect.

According to a ninth aspect, a communication system is provided. The communication system includes an apparatus that has a function of implementing the methods and the possible designs in the first aspect and an apparatus that has a function of implementing the methods and the possible designs in the second aspect. The apparatus that has the function of implementing the methods and the possible designs in the first aspect may be a network device, and the apparatus that has the function of implementing the methods and the possible designs in the second aspect may be a terminal device.

Specifically, for beneficial effects of other aspects, refer to the beneficial effects described in the first aspect and the second aspect.

### BRIEF DESCRIPTION OF DRAWINGS

FIG. 1 is a diagram of an example of a communication system according to this application;

FIG. 2 is a diagram of a CSI sounding and feedback solution in a MIMO technology according to this application;

FIG. 3 is a diagram of a CSI sounding and feedback solution in another MIMO technology according to this application;

FIG. 4 is a diagram of an example of a RIS-assisted MIMO communication system according to this application;

FIG. 5 is a diagram of a CSI sounding and feedback solution in another MIMO technology according to this application;

FIG. 6 is a diagram of a CSI sounding and feedback solution in another MIMO technology according to this application;

FIG. 7 is a diagram of a CSI sounding and feedback solution in another MIMO technology according to this application;

FIG. 8 is a block diagram of an example of a communication apparatus according to this application; and

FIG. 9 is a block diagram of another example of a communication apparatus according to this application.

### DESCRIPTION OF EMBODIMENTS

The following describes technical solutions of this application with reference to accompanying drawings.

The technical solutions in embodiments of this application may be applied to various communication systems, for example, a global system for mobile communications (global system for mobile communications, GSM), an enhanced data rate for global system for mobile communications evolution (enhanced data rate for GSM evolution, EDGE) system, a code division multiple access 2000 (code division multiple access, CDMA2000) system, a wideband code division multiple access (wideband code division multiple access, WCDMA) system, a time division-synchronous code division multiple access (time division-synchronous code division multiple access, TD-SCDMA) system, a narrowband-internet of things (narrowband-internet of things, NB-LoT) system, a general packet radio service (general packet radio service, GPRS), a long term evolution (long term evolution, LTE) system, a frequency division duplex (frequency division duplex, FDD) system, an LTE time division duplex (time division duplex, TDD) system, a universal mobile telecommunications system (universal mobile telecommunications system, UMTS), a worldwide interoperability for microwave access (worldwide interoperability for microwave access, WiMAX) communication system, a 5th generation (5th generation, 5G) system or a new radio (new radio, NR) system, and a future communication system.

By way of example, and not limitation, in embodiments of this application, a terminal device may also be referred to as user equipment (User Equipment, UE), an access terminal, a subscriber unit (subscriber unit), a subscriber station, a mobile station, a remote station, a remote terminal, a mobile device, a user terminal, a terminal, a wireless communication device, a user agent, or a user apparatus. The terminal device may be a station (STATION, ST) in a WLAN, and may be a cellular phone (cellular phone), a cordless phone, a smartphone, a wireless data card, a session initiation protocol (Session Initiation Protocol, SIP) phone, a wireless local loop (Wireless Local Loop, WLL) station, a personal digital assistant (Personal Digital Assistant, PDA), a tablet computer, a laptop computer, a machine-type communication terminal, a wireless modem, a handheld device with a wireless communication function, an in-vehicle device, a wearable device, a computing device, or another processing device connected to a wireless modem, for example, a terminal device in a 5G network, a terminal device in a future evolved public land mobile network (Public Land Mobile Network, PLMN), or the like.

By way of example, and not limitation, in embodiments of this application, the terminal device may alternatively be a wearable device. The wearable device may also be referred to as a wearable intelligent device, and is a general term of a wearable device that is intelligently designed and developed for daily wear by using a wearable technology, for example, glasses, gloves, a watch, clothing, and shoes. The wearable device is a portable device that can be directly worn on the body or integrated into clothes or an accessory of a user. The wearable device is not only a hardware device, but also implements a powerful function through software support, data exchange, and cloud interaction. In a broad sense, wearable intelligent devices include full-featured and large-size devices that can implement all or some functions without depending on smartphones, for example, smart watches or smart glasses, and devices that focuses on only one type of application and need to be used together with other devices such as smartphones, for example, various smart bands and smart jewelry for monitoring physical signs.

Alternatively, in embodiments of this application, the terminal device may be a terminal device in an internet of things (Internet of Things, IoT) system. IoT is an important composition part of information technology development in the future, and has a main technical feature in which things are connected to a network by using a communication technology to implement a man-machine connected and thing-thing connected intelligent network.

By way of example, and not limitation, in embodiments of this application, a base station (base station, BS) is an apparatus that is deployed in a radio access network and that provides a wireless communication function for a terminal device. The BS may also be referred to as an access network device, a network device, or a base station device.

In systems using different radio access technologies, names of base station functions may be different. For example, the base station may be a device such as an access network device that is configured to communicate with a terminal device, or the base station may be an access point (access point, AP) in a WLAN, a base station (base transceiver station, BTS) in a GSM or CDMA, a base station (NodeB, NB) in WCDMA, a gNB in a new radio (new radio, NR) system, an evolved NodeB (evolved NodeB, eNB, or eNodeB) in LTE, a relay station or an access point, an in-vehicle device, a wearable device, an access network device (radio access network, RAN) in a future 5G network, an access network device in a future evolved PLMN network, or the like.

In addition, in embodiments of this application, a wireless communication system usually includes cells, each cell includes a base station, and the base station provides a communication service for a plurality of terminal devices. The base station includes a baseband unit (baseband unit, BBU) and a remote radio unit (remote radio unit, RRU). The BBU and RRU may be placed in different places or in a same equipment room. For example, the RRU is remotely placed in a high-traffic area, and the BBU is placed in a central equipment room. The RRU and the BBU may alternatively be different components in a same rack. The terminal device communicates with the base station via a transmission resource (for example, a frequency domain resource or a frequency spectrum resource) used for a cell. The cell may be a cell corresponding to the base station. The cell may belong to a macro base station, or a base station corresponding to a small cell (small cell). The small cell herein may include a metro cell (metro cell), a micro cell (micro cell), a pico cell (pico cell), a femto cell (femto cell), or the like. These small cells have features of small coverage and low transmit power, and are applicable to providing a high-speed data transmission service.

In embodiments of this application, the terminal device or the access network device includes a hardware layer, an operating system layer running on the hardware layer, and an application layer running on the operating system layer. The hardware layer includes hardware such as a central processing unit (Central Processing Unit, CPU), a memory management unit (Memory Management Unit, MMU), and a memory (which is also referred to as a main memory). An operating system may be any one or more computer operating systems that implement service processing through a process (Process), such as a Linux operating system, a Unix operating system, an Android operating system, an iOS operating system, or a Windows operating system. The application layer includes applications such as a browser, an address book, word processing software, and instant messaging software. In addition, a specific structure of an execution body of a method provided in embodiments of this application is not particularly limited in embodiments of this application, provided that a program that records code of the method provided in embodiments of this application can be run to perform communication according to the method provided in embodiments of this application. For example, the execution body of the method provided in embodiments of this application may be the terminal device or the network device, or a functional module that can invoke and execute the program in the terminal device or the network device.

In addition, aspects or features in embodiments of this application may be implemented as a method, an apparatus or a product that uses standard programming and/or engineering technologies. The term “product” used in this application covers a computer program that can be accessed from any computer-readable component, carrier or medium. For example, the computer-readable medium may include but is not limited to: a magnetic storage component (for example, a hard disk, a floppy disk, or a magnetic tape), an optical disc (for example, a compact disc (Compact Disc, CD) or a digital versatile disc (Digital Versatile Disc, DVD)), or a smart card and a flash memory component (for example, an erasable programmable read-only memory (Erasable Programmable Read-Only Memory, EPROM), a card, a stick, or a key drive). In addition, various storage media described in this specification may represent one or more devices and/or other machine-readable media that are configured to store information. The term “machine-readable media” may include but is not limited to a radio channel, and various other media that can store, contain and/or carry instructions and/or data.

It should be noted that in embodiments of this application, a plurality of application programs may be run at this application layer. In this case, an application program for performing the communication methods in embodiments of this application and an application program configured to control a receiving end device to implement an action corresponding to received data may be different application programs.

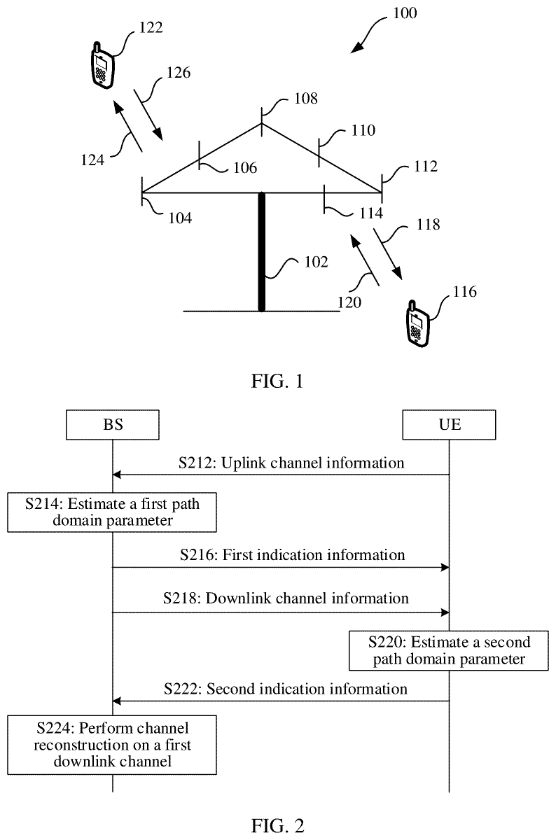

FIG. 1 is a diagram of a system 100 to which a communication method according to an embodiment of this application is applicable. As shown in FIG. 1, the system 100 includes a base station 102, and the base station 102 may include one or more antennas, for example, antennas 104, 106, 108, 110, 112, and 114. In addition, the base station 102 may additionally include a transmitter chain and a receiver chain, and a person of ordinary skill in the art may understand that both the transmitter link and the receiver link may include multiple components (for example, a processor, a modulator, a multiplexer, a demodulator, a demultiplexer, and an antenna) related to signaling sending and receiving.

The base station 102 may communicate with a plurality of terminal devices (for example, a terminal device 116 and a terminal device 122). However, it may be understood that, the base station 102 may communicate with any quantity of terminal devices similar to the terminal device 116 or the terminal device 122. The terminal devices 116 and 122 each may be, for example, a cellular phone, a smartphone, a portable computer, a handheld communication device, a handheld computing device, a satellite radio apparatus, a global positioning system, a PDA, and/or any other appropriate device configured to perform communication in the wireless communication system 100.

As shown in FIG. 1, the terminal device 116 communicates with the antennas 112 and 114. The antennas 112 and 114 send information to the terminal device 116 over a downlink channel (also referred to as a forward link) 118, and receive information from the terminal device 116 over an uplink channel (also referred to as a reverse link) 120. In addition, the terminal device 122 communicates with the antennas 104 and 106. The antennas 104 and 106 send information to the terminal device 122 over a downlink channel 124, and receive information from the terminal device 122 over an uplink channel 126.

For example, in a frequency division duplex (frequency division duplex, FDD) system, the downlink channel 118 and the uplink channel 120 may use different frequency bands, and the downlink channel 124 and the uplink channel 126 may use different frequency bands.

For another example, in a time division duplex (time division duplex, TDD) system and a full duplex (full duplex) system, the downlink channel 118 and the uplink channel 120 may use a common frequency band, and the downlink channel 124 and the uplink channel 126 may use a common frequency band.

Each antenna (or an antenna group that includes a plurality of antennas) and/or an area that are/is designed for communication are/is referred to as a sector of the base station 102. For example, an antenna group may be designed to communicate with a terminal device in the sector of the coverage area of the base station 102. The base station may send, by using a single antenna or a plurality of antenna transmit diversities, a signal to all terminal devices in a sector corresponding to the network device. In a process in which the base station 102 communicates with the terminal devices 116 and 122 through the forward links 118 and 124 respectively, a transmit antenna of the base station 102 can also improve signal-to-noise ratios of the forward links 118 and 124 by using beamforming. In addition, in comparison with a manner in which the base station sends a signal to all terminal devices served by the network device by using a single antenna or a plurality of antenna transmit diversities, when the base station 102 sends, through beamforming, a signal to the terminal devices 116 and 122 that are randomly distributed within related coverage, less interference is caused to a mobile device in a neighboring cell.

In a given time, the base station 102, the terminal device 116, or the terminal device 122 may be a wireless communication sending apparatus and/or a wireless communication receiving apparatus. When sending data, the wireless communication sending apparatus may encode data for transmission. Specifically, the wireless communication transmitting apparatus may obtain (for example, generated, received from other communication apparatuses, or stored in memory) a number of data bits to be transmitted to the wireless communication receiving apparatus through the channel. The data bits may be included in a transport block (or a plurality of transport blocks) of data, and the transport block may be segmented to generate a plurality of code blocks.

In addition, the communication system 100 may be a PLMN network, a D2D network, an M2M network, an IoT network, or another network. FIG. 1 is merely a simplified diagram used as an example. Another base station may further be included in the network, and is not shown in FIG. 1.

In the TDD system, because uplink and downlink channels are reciprocal, a base station side may perform downlink transmission by using a result of uplink channel estimation after completing uplink channel estimation.

In other words, in the TDD system, each terminal device only needs to send pilot signals whose quantity is equal to a quantity of antenna ports (which may be simply one port) of the terminal device to the base station, so that the base station performs uplink and downlink channel estimation without considering a quantity of antenna ports of the base station. This is because all antenna ports of the base station receive a same pilot. Therefore, the base station may use a single uplink pilot transmission to estimate a channel for each of the antenna ports.

However, in the FDD system, because frequencies used for uplink and downlink channels are different, properties of the downlink channel may be completely different from those of the uplink channel, and an estimated uplink channel cannot be used for downlink transmission.

Therefore, in the FDD system, the downlink channel needs to be estimated in a downlink direction. To be specific, the downlink channel needs to be estimated on the terminal device side, and then a result of the downlink channel estimation is fed back to the base station on the uplink channel. In the FDD mode, the downlink channel is estimated on the terminal device side.

Therefore, each antenna port needs to be used to send a downlink pilot signal. As a result, channel estimation overheads in FDD increase with a quantity of transmit antennas of the base station, while channel estimation overheads in TDD increase only with a quantity of simultaneous terminal devices.

MIMO is an important technology for improving a system capacity and spectral efficiency in a wireless communication system. A large quantity of antennas or logical ports of a base station are usually used in the MIMO technology, resulting in high corresponding downlink pilot overheads and uplink feedback overheads. How to reduce downlink pilot overheads and uplink feedback overheads in the MIMO technology has become a bottleneck problem.

By way of example, and not limitation, in embodiments of this application, the MIMO technology is used as an example to describe the technical solutions of this application.

This application provides a CSI sounding and feedback solution in a MIMO technology below.

It should be noted that, by way of example, and not limitation, the network device in embodiments of this application is described by using a BS as an example, and the terminal device is described by using UE as an example.

In a scenario in which uplink and downlink channels are not reciprocal, step S212: The UE sends uplink channel information to the BS.

Specifically, by way of example, and not limitation, the uplink channel information may be uplink channel pilot information. In this application, an example in which the uplink channel information is the uplink channel pilot information is used for description.

Step S212 can avoid a problem of excessively high pilot overheads of downlink channel sounding when the MIMO technology is used. Regardless of whether the uplink channel and the downlink channel are reciprocal, in step S212, the UE side may send the uplink channel pilot information to the BS side, and the UE sends pilot information whose quantity is equal to a quantity of antenna ports (which may be simply one port) of the UE to the BS, so that the BS estimates a first path domain parameter.

Specifically, the first path domain parameter is a path domain parameter shared by the uplink channel and the downlink channel between the BS and the UE.

Step S214: The BS may estimate the path domain parameter shared by the uplink channel and the downlink channel between the BS and the UE based on uplink channel pilot receiving information.

In other words, the first path domain parameter of the uplink channel that is estimated by the BS may be used for channel estimation of the downlink channel.

Specifically, the first path domain parameter includes a power coefficient, a direction angle, a Doppler factor, and the like of each path of the uplink channel.

It should be understood that when the uplink channel has a plurality of paths, the power coefficient, the direction angle, and the Doppler factor include a power coefficient, a direction angle, and a Doppler factor that are of each path.

Step S216: The BS sends first indication information to the UE, where the first indication information indicates the first path domain parameter to the UE.

Specifically, by way of example, and not limitation, the first indication information may indicate the first path domain parameter by using a mapping table, or may indicate the first path domain parameter by using an index.

In addition, in step S218, the BS sends downlink channel information to the UE.

Specifically, by way of example, and not limitation, the downlink channel information may be downlink channel pilot information. In this application, an example in which the downlink channel information is the downlink channel pilot information is used for description.

Specifically, the downlink channel pilot information is sparsely sent by the BS in a space domain dimension, and a quantity of ports for sending is obviously less than a quantity of antennas of the BS.

For example, if the BS has M antenna ports, the BS needs to send the downlink channel pilot information to the UE only through the N antenna ports, where 1≤N<M.

In addition, the antenna port may also be referred to as an antenna unit.

It may also be understood as that the BS sends the downlink channel pilot information to the UE through some antenna ports of the BS by using the first path domain parameter as a reference. The downlink channel pilot information and the first path domain parameter are used by the UE to estimate a second path domain parameter, where the second path domain parameter is a path domain parameter that is of the downlink channel between the BS and the UE and that is different from that of the uplink channel. In other words, the downlink channel pilot information is used to estimate a specific downlink channel state (specific CSI) path domain parameter.

Step S220: The UE estimates the specific downlink channel state path domain parameter, namely, the second path domain parameter, based on the first path domain parameter and the uplink channel pilot receiving information.

Specifically, the specific downlink channel state path domain parameter includes an initial phase.

It should be understood that when the downlink channel has a plurality of paths, the initial phase includes an initial phase of each path.

Step S222: The UE sends second indication information to the BS, where the second indication information indicates the estimated second path domain parameter.

Specifically, by way of example, and not limitation, the second indication information may indicate the second path domain parameter by using a mapping table, or may indicate the second path domain parameter by using an index.

Step S224: The BS performs channel reconstruction on the downlink channel between the BS and the UE based on the estimated first path domain parameter and the second path domain parameter estimated by the UE.

Specifically, the BS reconstructs a full information matrix of the downlink channel based on specific path domain parameter values estimated in step S214 and step S220.

In comparison with a current technology, in this embodiment, problems of high pilot overheads of downlink channel sounding and high uplink channel feedback overheads can be avoided, and accuracy of downlink channel estimation can be improved.

This application provides a CSI sounding and feedback solution in another MIMO technology below.

It should be noted that, by way of example, and not limitation, the terminal device in embodiments of this application is described by using UE as an example.

In a scenario in which uplink and downlink channels are not reciprocal, step S310: The UE sends first parameter information to a BS, where the first parameter information indicates an antenna array parameter of the UE. The antenna array parameter of the UE is denoted as an antenna array parameter #A herein.

Specifically, the UE may send the antenna array parameter #A to the BS via signaling.

Specifically, the antenna array parameter #A includes at least one of a topology form, an element spacing, an element pattern, and a polarization form that are of an antenna array of the UE. The topology form of the antenna array includes a linear array topology, a planar array topology, a circular array topology, or the like.

It should be understood that more information included in the antenna array parameter #A indicates more accurate channel estimation.

Step S312: The UE sends uplink channel pilot information to the BS at a plurality of moments t1 to tn of a symbol granularity. The BS receives, at the plurality of moments t1 to tn of the symbol granularity, the uplink channel pilot information sent by the UE.

Step S314: The BS estimates a first path domain parameter of an uplink channel and a downlink channel between the BS and the UE based on the received antenna array parameter #A, uplink sounding pilot receiving information, and an antenna array parameter of the BS, where the first path domain parameter is denoted as a common path domain parameter #1. The antenna array parameter of the BS is denoted as an antenna array parameter #B herein.

Specifically, the antenna array parameter #B includes at least one of a topology form, an element spacing, an element pattern, and a polarization form that are of an antenna array of the BS. The topology form of the antenna array includes a linear array topology, a planar array topology, a circular array topology, or the like.

It should be understood that more information included in the antenna array parameter #B indicates more accurate channel estimation.

Regardless of whether the uplink and downlink channels are reciprocal, the common path domain parameter #1 of the uplink channel and the downlink channel is the same and shared.

Specifically, the common path domain parameter #1 includes a power coefficient, a direction angle, a Doppler factor, and the like of each path in the uplink channel. The direction angle may be a receiving array incident angle and a transmitting array emergent angle of each path in the uplink channel.

Specifically, by way of example, and not limitation, estimation methods used by the BS to estimate the common path domain parameter #1 include methods such as maximum likelihood estimation (maximum likelihood estimation, MLE), maximum a posteriori (maximum a posteriori, MAP), and sparse Bayesian learning (sparse Bayesian learning, SBL) that are based on the Bayesian criterion.

By way of example, and not limitation, the following uses the MLE method as an example for description.

Step 1: The BS receives, at the plurality of moments t1 to tn of the symbol granularity, the uplink channel pilot information sent by the UE, where uplink channel pilot receiving information on the BS side may be expressed as:

$$Y ( t ) = H ( {φ}_{bs} , {φ}_{ue} , θ , vt ) X + Z , 〈 \begin{matrix}H ( {φ}_{b s} , {φ}_{u e} , θ , vt ) = {A}_{{φ}_{b s}} {D}_{p , θ , vt} {A}_{{φ}_{u e}}^{T} \\ {[ {D}_{p , θ , vt} ]}_{m , m} = {p}_{m} {e}^{j {θ}_{m}} {e}^{j 2 π {f}_{c} {v}_{m} t} \\ {A}_{{φ}_{b s}} = [ {a}_{{φ}_{bs , 1}} … {a}_{{φ}_{bs , {N}_{L}}} ] \\ {A}_{{φ}_{u e}} = [ {a}_{{φ}_{bs , 1}} … {a}_{{φ}_{ue , {N}_{L}}} ]\end{matrix} 〉$$

H(φ_{bs},φᵤₑ,θ,vt) represents an N_{bs}×Nᵤₑ-dimensional uplink channel matrix, X represents Nᵤₑ×Nᵤₑ-dimensional uplink sounding pilot sending information, Y(t) represents N_{bs}×Nᵤₑ-dimensional uplink sounding pilot receiving information, Z represents N_{bs}×N_{bs}-dimensional additive noise, N_{L} represents a quantity of multipaths, pₘ, θₘ, νₘ, φ_{bs,m}, and φ_{ue,m} respectively represent a power coefficient, an initial phase, a Doppler factor, a receiving array incident angle, and a transmitting array emergent angle that are of an m^{th} path, and a_{φ} represents an array steering vector when the receiving array incident angle or the transmitting array emergent angle is φ.

Specifically, a_{φ} may be determined by the foregoing antenna array parameter #A or antenna array parameter #B. A single-polarized uniform linear array is used as an example, an array steering vector of the array may be determined by using the following formula:

$${a}_{φ} = {N}^{- 0.5} [ \begin{matrix}{e}^{- j 2 {πλ}_{c}^{- 1} ( Δ sin φ ) ( 0 )} \\ {e}^{- j 2 {πλ}_{c}^{- 1} ( Δ sin φ ) ( 1 )} \\ … \\ {e}^{- j 2 {πλ}_{c}^{- 1} ( Δ sin φ ) ( N - 1 )}\end{matrix} ]$$

Δ represents an element spacing, and N represents a quantity of elements.

Step 2: The BS combines the uplink channel pilot receiving information at the plurality of moments t1 to tn.

$$Y = [ \begin{matrix}Y ( {t}_{1} ) \\ … \\ Y ( {t}_{n} )\end{matrix} ] ,$$

$$X = [ \begin{matrix}X ( {t}_{1} ) \\ … \\ X ( {t}_{n} )\end{matrix} ] ,$$

$$H = [ \begin{matrix}H ( {φ}_{bs} , {φ}_{ue} , θ , {vt}_{1} ) & 0 & 0 \\ 0 & … & 0 \\ 0 & 0 & H ( {φ}_{bs} , {φ}_{ue} , θ , {vt}_{n} )\end{matrix} ]$$

Step 3: The BS estimates, based on the combined uplink channel pilot receiving information by using the MLE method, a path domain parameter shared by the uplink channel and the downlink channel, namely, the foregoing common path domain parameter #1.

$$( {\hat{φ}}_{bs} , {\hat{φ}}_{ue} , \hat{θ} , \hat{v} ) = {arg max}_{{φ}_{bs} , {φ}_{ue} , θ , v} \{ p ( Y \vert {φ}_{bs} , {φ}_{ue} , θ , v ) = ‖ {Y}_{t} - H ( {φ}_{bs} , {φ}_{ue} , θ , vt ) X ‖ \}$$

Through the foregoing formula, a value of the common path domain parameter #1 may be obtained: \hat{φ}_{bs}, \hat{φ}ᵤₑ, \hat{v}, or the like.

In addition, a distribution range of the common path domain parameter #1 may be determined based on corresponding prior information for discretization, to reduce estimation complexity. For example, a distribution range of the Doppler factor v may be determined based on a moving speed in an application scenario.

It should be noted that, in a scenario in which the uplink channel and the downlink channel are reciprocal, all parameters required for reconstructing a full information matrix of the downlink channel may also be directly estimated in Step 3, including \hat{φ}_{bs}, \hat{φ}ᵤₑ, \hat{v}, \hat{θ}, and the like.

Step S316: The BS sends the estimated values \hat{φ}_{bs}, \hat{φ}ᵤₑ, and \hat{v} of the common path domain parameter #1 to the UE.

Optionally, the BS sends second parameter information to the UE, where the second parameter information indicates the antenna array parameter of the BS, namely, the antenna array parameter #B.

Step S318: The BS sends downlink channel pilot information to the UE through some antennas in a space domain dimension.

Specifically, the downlink channel pilot information may be a channel state information parameter reference signal (channel state information parameter reference signal, CSIP-RS). The CSIP-RS is a new type of time-frequency sparse pilot whose code length is far less than a quantity of antennas or a quantity of antenna ports of the BS for transmission and whose time domain period exceeds channel coherence time.

Specifically, an order of magnitude of the downlink channel pilot information sent by the BS is significantly less than the quantity of antennas of the BS.

The BS does not need to send downlink channel pilot information whose quantity is equal to a quantity of antennas or logical ports of the BS, so that downlink pilot overheads on the BS side can be reduced.

In addition, the downlink channel pilot information sent by the BS may be sent at equal intervals or unequal intervals through BS array antennas. This is not limited in this application.

By way of example, and not limitation, a pilot codebook of the CSI-HP-RS pilot information may be constructed by using the following three methods:

In the first method, Nₚ ports are sampled at equal intervals from N_{bs}-dimensional BS array antennas to transmit the CSI-HP-RS pilot information. In an example in which N_{bs}=4 and Nₚ=2, a pilot codebook of the corresponding CSI-HP-RS pilot information may be expressed as:

$${X}^{T} = [ \begin{matrix}1 & 0 & 0 & 0 \\ 0 & 0 & 1 & 0\end{matrix} ]$$

X^{T} represents a transpose matrix of a downlink channel pilot information matrix X, a vertical direction of X^{T} represents a resource element (resource element, RE) dimension, and a horizontal direction of X^{T} represents an antenna dimension.

In the second method, the CSI-HP-RS pilot information is transmitted through all N_{bs}-dimensional BS array antennas, and codewords are orthogonal. In an example in which N_{bs}=4, a pilot codebook of the corresponding CSI-HP-RS pilot information may be expressed as:

$${X}^{T} = [ \begin{matrix}1 & 1 & 1 & 1 \\ 1 & - 1 & 1 & - 1\end{matrix} ]$$

X^{T} represents a transpose matrix of a downlink channel pilot sending information matrix X, a vertical direction of X^{T} represents an RE dimension, and a horizontal direction of X^{T} represents an antenna dimension.

In the third method, the CSI-HP-RS pilot information is transmitted through all N_{bs}-dimensional BS array antennas, and codewords are not necessarily orthogonal. In an example in which N_{bs}=4, a pilot codebook of the corresponding CSI-HP-RS pilot information may be expressed as:

$${X}^{T} [ \begin{matrix}{x}_{11} & {x}_{12} & {x}_{13} & {x}_{14} \\ {x}_{21} & {x}_{22} & {x}_{23} & {x}_{24}\end{matrix} ]$$

X^{T} represents a transpose matrix of a downlink channel pilot sending information matrix X, a vertical direction of X^{T} represents an RE dimension, and a horizontal direction of X^{T} represents an antenna dimension.

Step S320: The UE may estimate a second path domain parameter between the BS and the UE based on the downlink pilot information and the common path domain parameter #1, where the second path domain parameter may represent a downlink channel path domain parameter between the BS and the UE, and is denoted as a downlink channel path domain parameter #1.

Optionally, the UE may alternatively estimate the downlink channel path domain parameter #1 based on the downlink pilot information, the common path domain parameter #1, and the antenna array parameter #A.

Optionally, the UE may alternatively estimate the downlink channel path domain parameter #1 based on the downlink pilot information, the common path domain parameter #1, the antenna array parameter #A, and the antenna array parameter #B.

It should be understood that when the downlink channel path domain parameter #1 is estimated with reference to the antenna array parameter #A and/or the antenna array parameter #B, the estimated downlink channel path domain parameter #1 is more accurate.

Specifically, the downlink channel path domain parameter #1 may include an initial phase.

Specifically, by way of example, and not limitation, estimation methods used by the UE to estimate the downlink channel path domain parameter #1 include methods such as MLE, MAP, and SBL that are based on the Bayesian criterion.

By way of example, and not limitation, the following uses the MLE method as an example for description.

Step 1: The UE receives, at a plurality of moments t1 to tn of a symbol granularity, downlink channel pilot information sent by the BS, where downlink channel pilot receiving information may be expressed as:

$$Y ( t ) = H ( {φ}_{bs} , {φ}_{ue} , θ , vt ) X + Z , 〈 \begin{matrix}H ( {φ}_{bs} , {φ}_{ue} , θ , vt ) = {A}_{{φ}_{ue}} {D}_{p , θ , vt} {A}_{{φ}_{bs}}^{T} \\ {[ {D}_{p , θ , vt} ]}_{m , m} = {p}_{m} {e}^{j {θ}_{m}} {e}^{j 2 π {f}_{c} {v}_{m} t} \\ {A}_{{φ}_{bs}} = [ {a}_{{φ}_{bs , 1}} … {a}_{{φ}_{bs , {N}_{L}}} ] \\ {A}_{{φ}_{ue}} = [ {a}_{{φ}_{ue , 1}} … {a}_{{φ}_{ue , {N}_{L}}} ]\end{matrix} 〉$$

H(φ_{bs},φᵤₑ,θ,vt) represents an Nᵤₑ×N_{bs}-dimensional downlink channel matrix, X represents N_{bs}×N_{y}-dimensional downlink sounding pilot sending information, Y(t) represents Nᵤₑ×Nₚ-dimensional downlink sounding pilot receiving information, Z represents Nᵤₑ×Nᵤₑ-dimensional additive noise, N_{L} represents a quantity of multipaths, pₘ, θₘ, νₘ, φ_{bs,m}, and φ_{ue,m} respectively represent a power coefficient, an initial phase, a Doppler factor, a receiving array incident angle, and a transmitting array emergent angle that are of an m^{th} path, and a_{φ} represents an array steering vector when the receiving array incident angle or the transmitting array emergent angle is φ.

Specifically, a_{φ} may be determined by the foregoing antenna array parameter #A or antenna array parameter #B. A single-polarized uniform linear array is used as an example, an array steering vector of the array may be determined by using the following formula:

$${a}_{φ} = {N}^{- 0.5} [ \begin{matrix}{e}^{- j 2 {πλ}_{c}^{- 1} ( Δ sin φ ) ( 0 )} \\ {e}^{- j 2 {πλ}_{c}^{- 1} ( Δ sin φ ) ( 1 )} \\ … \\ {e}^{- j 2 {πλ}_{c}^{- 1} ( Δ sin φ ) ( N - 1 )}\end{matrix} ]$$

Δ represents an element spacing, and N represents a quantity of elements.

Step 2: The UE combines the downlink channel pilot receiving information at the plurality of moments t1 to tn.

$$Y = [ \begin{matrix}Y ( {t}_{1} ) \\ … \\ Y ( {t}_{n} )\end{matrix} ] ,$$

$$X = [ \begin{matrix}X ( {t}_{1} ) \\ … \\ X ( {t}_{n} )\end{matrix} ] ,$$

$$H = [ \begin{matrix}H ( {φ}_{bs} , {φ}_{ue} , θ , {vt}_{1} ) & 0 & 0 \\ 0 & … & 0 \\ 0 & 0 & H ( {φ}_{bs} , {φ}_{ue} , θ , {vt}_{n} )\end{matrix} ]$$

Step 3: The UE estimates the downlink channel path domain parameter #1 based on the combined downlink channel pilot receiving information by using the MLE method.

$$( \hat{θ} ) = {arg max}_{θ} \{ p ( Y \vert {\hat{φ}}_{bs} , {\hat{φ}}_{ue} , θ , \hat{v} ) = ‖ {Y}_{t} - H ( {\hat{φ}}_{bs} , {\hat{φ}}_{ue} , θ , \hat{v} t ) X ‖ \}$$

Through the foregoing formula, the downlink channel path domain parameter #1 may be obtained, that is, an initial phase value \hat{θ} may be obtained.

Step S322: The UE sends the obtained downlink channel path domain parameter #1 to the BS.

Step S324: The BS reconstructs a full channel information matrix of the downlink channel between the BS and the UE based on the values (\hat{φ}_{bs},\hat{φ}ᵤₑ,\hat{ν}) of the common path domain parameter #1 and the value (\hat{θ}) of the downlink channel path domain parameter #1. The full channel information matrix of the downlink channel between the BS and the UE is denoted as a full information matrix #1 of the downlink channel.

By way of example, and not limitation, a method for constructing the full information matrix #1 of the downlink channel by the BS is as follows:

Step 1: Obtain parameters of each path. Parameters are classified by using each path as a unit. Each unit includes own independent parameters, that is, includes known parameters such as \hat{φ}_{bs}, \hat{φ}ᵤₑ, \hat{ν} and \hat{θ} calculated in the foregoing steps.

Step 2: Construct components of each path. An array response corresponding to a direction angle of each path, a Doppler time-varying phase rotation corresponding to a Doppler factor of each path, an initial phase complex value of each path, and the like are respectively generated based on the parameters \hat{φ}_{bs}, \hat{φ}ᵤₑ, \hat{ν} and \hat{θ} of each path.
(1) Array response corresponding to a direction angle of each path:
\textcircled{1} Array response corresponding to a direction angle of each path on the BS side:

$$Path 1 : {φ}_{b s , 1} ⇒ {a}_{{φ}_{bs , 1}}$$

$$Path 2 : {φ}_{b s , 2} ⇒ {a}_{{φ}_{b s , 2}}$$

$$…$$

$$Path {N}_{L} : {φ}_{b s , {N}_{L}} ⇒ {a}_{{φ}_{bs , {N}_{L}}}$$

\textcircled{2} Array response corresponding to a direction angle of each path on the UE side:

$$Path 1 : {φ}_{ue , 1} ⇒ {a}_{{φ}_{ue , 1}}$$

$$Path 2 : {φ}_{ue , 2} ⇒ {a}_{{φ}_{ue , 2}}$$

$$…$$

$$Path {N}_{L} : {φ}_{ue , {N}_{L}} ⇒ {a}_{{φ}_{ue , {N}_{L}}}$$

(2) Doppler time-varying rotation corresponding to a Doppler factor of each path:

$$Path 1 : {v}_{1} {e}^{j 2 π {f}_{c} {v}_{1} t}$$

$$Path 2 : {v}_{2} {e}^{j 2 π {f}_{c} {v}_{2} t}$$

$$…$$

$$Path {N}_{L} : {v}_{{N}_{L}} {e}^{j 2 π {f}_{c} {v}_{{N}_{L}} t}$$

(3) Initial phase complex value corresponding to an initial phase of each path:

$$Path 1 : {θ}_{1} {e}^{j {θ}_{1}}$$

$$Path 2 : {θ}_{2} {e}^{j {θ}_{2}}$$

$$…$$

$$Path {N}_{L} : {θ}_{{N}_{L}} {e}^{j {θ}_{{N}_{L}}}$$

Step 3: Reconstruct the full information matrix #1 of the time-varying downlink channel based on the initial phase complex value corresponding to the initial phase of each path, the array response corresponding to the direction angle of each path, and the time-varying phase rotation corresponding to the Doppler factor of each path.

Full information matrix #1 of the downlink channel:

$$\hat{H} ( t ) = {p}_{1} {e}^{j {θ}_{1}} {e}^{j 2 π {f}_{c} {v}_{1} t} {a}_{{φ}_{ue , 1}} {a}_{{φ}_{bs , 1}}^{T} + {p}_{2} {e}^{j {θ}_{2}} {e}^{j 2 π {f}_{c} {v}_{2} t} {a}_{{φ}_{u e , 2}} {a}_{{φ}_{bs , 1}}^{T} + … + {p}_{{N}_{L}} {e}^{j {θ}_{{N}_{L}}} {e}^{j 2 π {f}_{c} {v}_{{N}_{L}} t} {a}_{{φ}_{ue , {N}_{L}}} {a}_{{φ}_{bs , {N}_{L}}}^{T}$$

According to the technical solution of the foregoing embodiment, first, in this embodiment, the UE only needs to send uplink channel pilot signals whose quantity is equal to the quantity of antenna ports (which may be simply one port) of the UE to the BS, so that the BS estimates the common path domain parameter #1.

Next, in this embodiment, the BS only needs to sparsely send the downlink channel pilot information and the common path domain parameter #1 to the UE in the space domain dimension, without considering the quantity of antenna ports of the BS. This can greatly reduce downlink channel pilot overheads.

Further, in this embodiment, the UE needs to feed back only the downlink channel path domain parameter #1 to the BS, and a quantity of uplink feedbacks is reduced.

Finally, in this embodiment, the common path domain parameter #1 and the downlink channel path domain parameter #1 that are of each path before aliasing can be estimated, based on which the full information matrix #1 of the downlink channel is constructed, so that accuracy of channel estimation can be improved.

In addition, when there is an insurmountable obstacle between the BS and the UE, a non-line-of-sight channel exists between the BS and the UE. If a signal propagation environment is simple and there is no reflection path, a signal that can be received by the UE is very weak. If a reconfigurable intelligent surface (reconfigurable intelligent surface, RIS) array is used for assistance, a reflected beam may be manipulated to aim at the UE in a blind area and dynamically track the UE. This is equivalent to creating a virtual line-of-sight path, extending a coverage area of the BS.

In addition, when a signal transmission environment is simple, there is usually a lack of independent multipaths to transmit a signal, making it difficult to implement sufficient multi-stream transmission. Through reflection of the RIS array, a signal propagation path can be manually increased, to better implement multi-stream transmission, improve a throughput of hotspot UE, and so on.

This application provides a CSI sounding and feedback solution for a RIS array-assisted MIMO system (RIS-MIMO) below.

As shown in FIG. 4, FIG. 4 is a diagram of a reflection channel between a BS and a RIS array, a reflection channel between the RIS array and UE, and a direct channel between the BS and the UE in a RIS-MIMO system.

For brevity, the reflection channel between the BS and the RIS array may be denoted as a channel #2, the reflection channel between the RIS array and the UE may be denoted as a channel #3, and the direct channel between the BS and the UE may be denoted as a channel #1.

In addition, the channel #2 and the channel #3 may also be referred to as reflection channels. The channel #1 is referred to as a direct channel.

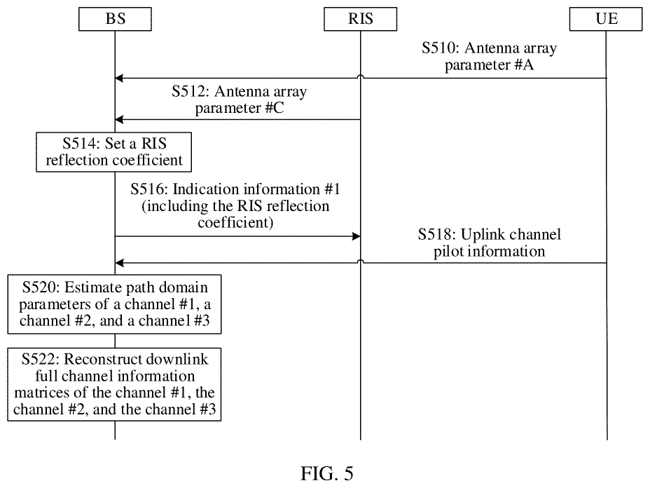

In a scenario in which an uplink channel and a downlink channel are reciprocal, only the uplink channel needs to be estimated, and then downlink transmission can be performed by using a result of uplink channel estimation. FIG. 5 is a diagram of a CSI sounding and feedback method in which an uplink channel and a downlink channel are reciprocal in a RIS-MIMO system.

Step S510: UE sends an antenna array parameter #A to a BS.

Step S512: A RIS array sends third parameter information to the BS, where the third parameter information indicates an antenna array parameter of the RIS array. The antenna array parameter of the RIS array is denoted as an antenna array parameter #C.

Specifically, the antenna array parameter #C includes at least one of a topology form, an element spacing, an element pattern, and a polarization form that are of an antenna array of the RIS. The topology form of the antenna array includes a linear array topology, a planar array topology, a circular array topology, or the like.

It should be understood that more information included in the antenna array parameter #C indicates more accurate estimation of a path domain parameter of the channel #2 and a path domain parameter of the channel #3.

Step S514: After receiving the antenna array parameter #C, the BS sets a reflection coefficient of the RIS array based on the antenna array parameter #C.

Specifically, the reflection coefficient of the RIS array is used to indicate the RIS array to reflect, at different moments by using different reflection coefficients, an uplink signal and a downlink signal that are transmitted through the channel #2 and the channel #3.

It should be understood that, only when the RIS array reflects, at different moments by using different reflection coefficients, an uplink signal and a downlink signal that are transmitted through the channel #2 and the channel #3, the BS side or the UE side can estimate channel state information of the channel #2 and the channel #3.

Step S516: The BS sends third indication information to the RIS array at a plurality of moments t1 to tn of a symbol granularity, where the third indication information is denoted as indication information #1, and the indication information #1 indicates the RIS array to reflect, by using different reflection coefficients, an uplink signal and a downlink signal that are transmitted through the channel #2 and the channel #3.

Step S518: The UE sends uplink channel pilot information to the BS at the plurality of moments t1 to tn of the symbol granularity. The BS receives, at the plurality of moments t1 to tn of the symbol granularity, the uplink channel pilot information sent by the UE.

Specifically, the uplink channel pilot information is not only directly sent to the BS through the channel #1, but also sent to the BS through the channel #2, reflected by the RIS array, and then sent to the BS through the channel #3.

Step S520: The BS estimates a first path domain parameter of the channel #1, a third path domain parameter of the channel #2, and a fifth path domain parameter of the channel #3 based on an antenna array parameter #B, the reflection coefficient of the RIS array, and the antenna array parameter #A, the antenna array parameter #C, and the uplink channel pilot receiving information that are received.

For brevity, the first path domain parameter of the channel #1 is denoted as a common path domain parameter #1, the third path domain parameter of the channel #2 is denoted as a common path domain parameter #2, and the fifth path domain parameter of the channel #3 is denoted as a common path domain parameter #3 herein.

Specifically, the estimated common path domain parameter #2 includes parameters such as \hat{φ}_{bs}, \hat{φ}ᵣᵢₛ, \hat{ν}, \hat{p}, and \hat{θ}; the estimated common path domain parameter #3 includes parameters such as \hat{φ}ᵣᵢₛ, \hat{φ}ᵤₑ, \hat{ν}, \hat{p}, and \hat{θ}; and the estimated common path domain parameter #1 includes parameters such as \hat{φ}_{bs}, \hat{φ}ᵤₑ, \hat{ν}, \hat{p}, and \hat{θ}.

A method for estimating the common path domain parameter #1, the common path domain parameter #2, and the common path domain parameter #3 by the BS is similar to that in step S314, and details are not described herein again.

Step S522: The BS reconstructs a downlink full channel information matrix #1, a downlink full channel information matrix #2, and a downlink full channel information matrix #3 of the channel #1, the channel #2, and the channel #3 respectively based on the estimated common path domain parameter #1, common path domain parameter #2, and common path domain parameter #3.

A method for constructing the full channel information matrix of each channel is similar to that in step S324, and details are not described herein again.

In this embodiment, the antenna array parameter #C of the RIS array is transferred to the BS, and the BS indicates the RIS array to reflect signals at different moments by using different reflection coefficients. In addition, the BS may estimate the path domain parameters of the uplink channels of the channel #1, the channel #2, and the channel #3 based on the antenna array parameter #A, the antenna array parameter #B, the antenna array parameter #C, and the uplink channel pilot information sent by the UE, and use the path domain parameters of the uplink channels for downlink transmission. In comparison with a case in which the BS directly estimates reflection channel matrices of the channel #2 and the channel #3, downlink channel pilot resource overheads can be reduced.

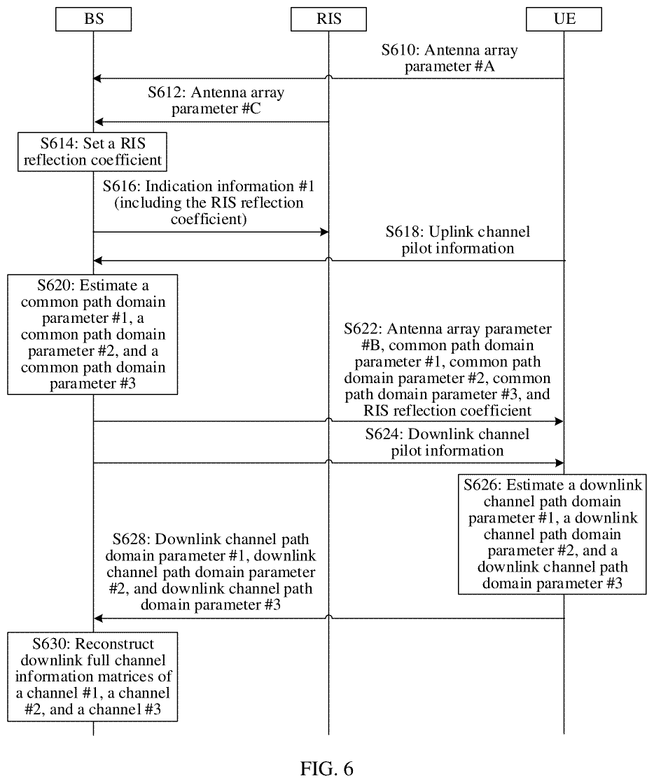

In a scenario in which uplink and downlink channels are not reciprocal, FIG. 6 is a diagram of a CSI sounding and feedback method in a RIS-MIMO system.

For step S610 to step S618, refer to step S510 to step S518. Details are not described herein again.

Step S620: A BS estimates a common path domain parameter #1, a common path domain parameter #2, and a common path domain parameter #3 of a channel #1, a channel #2, and a channel #3 respectively based on an antenna array parameter #B, a reflection coefficient of a RIS array, and an antenna array parameter #A, an antenna array parameter #C, and uplink channel pilot receiving information that are received.

Specifically, the common path domain parameter #2 of the channel #2 includes parameters such as \hat{φ}_{bs}, \hat{φ}ᵣᵢₛ, \hat{ν} and \hat{p}; the common path domain parameter #3 of the channel #3 includes parameters such as \hat{φ}ᵣᵢₛ, \hat{φ}ᵤₑ, \hat{ν} and \hat{p}; and the common path domain parameter #1 of the channel #1 includes parameters such as \hat{φ}_{bs}, \hat{φ}ᵤₑ, \hat{ν} and \hat{p}.

A method for estimating the common path domain parameter #1, the common path domain parameter #2, and the common path domain parameter #3 of the channel #1, the channel #2, and the channel #3 by the BS is similar to that in step S314, and details are not described herein again.

Step S622: The BS sends the estimated common path domain parameter #1, common path domain parameter #2, and common path domain parameter #3 of the channel #1, the channel #2, and the channel #3, and the reflection coefficient of the RIS array to the UE.

Optionally, the BS also sends the antenna array parameter #B to the UE.

Step S624: The BS sparsely sends downlink channel pilot information to the UE in a space domain dimension.

Specifically, the downlink channel pilot information may be a CSIP-RS. The CSIP-RS is a new type of time-frequency sparse pilot whose code length is far less than a quantity of antennas or a quantity of antenna ports of the BS for transmission and whose time domain period exceeds channel coherence time.

A method for constructing a pilot codebook of the CSI-HP-RS pilot information is described above, and details are not described herein again.

Specifically, the BS not only directly sends the downlink channel pilot information to the UE through the channel #1, but also delivers the downlink channel pilot information through the channel #2, and then sends the downlink channel pilot information to the UE through the channel #3 after the downlink channel pilot information is reflected by the RIS array.

Specifically, an order of magnitude of the downlink channel pilot information sent by the BS is significantly less than the quantity of antenna ports of the BS. The BS does not need to send downlink pilot information whose quantity is equal to a quantity of antennas or logical ports of the BS, so that downlink channel pilot overheads on the BS side can be reduced.

It should be understood that, the order of magnitude of the downlink channel pilot information delivered by the BS is significantly less than the quantity of antenna ports of the BS because the BS also delivers a common path domain parameter of the uplink channel and the downlink channel. The common path domain parameter may be used as a reference for the BS side, so that the BS side sends the downlink channel pilot information on some antenna ports of the BS side.

In addition, the downlink channel pilot information sent by the BS may be sent at equal intervals or unequal intervals through BS array antennas. This is not limited in this application.

Step S626: The UE estimates a second path domain parameter of the channel #1, a fourth path domain parameter of the channel #2, and a sixth path domain parameter of the channel #3 respectively based on downlink channel pilot receiving information, the common path domain parameter #1, the common path domain parameter #2, the common path domain parameter #3, the antenna array parameter #A, and the reflection coefficient of the RIS array.

For brevity, the second path domain parameter of the channel #1 is denoted as a downlink channel path domain parameter #1, the fourth path domain parameter of the channel #2 is denoted as a downlink channel path domain parameter #2, and the sixth path domain parameter of the channel #3 is denoted as a downlink channel path domain parameter #3.

Specifically, the downlink channel path domain parameter #1, the downlink channel path domain parameter #2, and the downlink channel path domain parameter #3 each include a parameter, namely, an initial phase \hat{θ}.

Specifically, by way of example, and not limitation, estimation methods used by the UE to estimate the downlink channel path domain parameter #1, the downlink channel path domain parameter #2, and the downlink channel path domain parameter #3 include methods such as MLE, MAP, and SBL that are based on the Bayesian criterion. For the estimation methods, refer to step S320. Details are not described herein again.

Step S628: The UE sends the estimated downlink channel path domain parameter #1, downlink channel path domain parameter #2, and downlink channel path domain parameter #3 to the BS.

Step S630: The BS reconstructs a downlink full channel information matrix #1 of the channel #1, a downlink full channel information matrix #2 of the channel #2, and a downlink full channel information matrix #3 of the channel #3 respectively based on the common path domain parameter #1 and the downlink channel path domain parameter #1 of the channel #1, the common path domain parameter #2 and the downlink channel path domain parameter #2 of the channel #2, and the common path domain parameter #3 and the downlink channel path domain parameter #3 of the channel #3 obtained above.

Specifically, for a method for constructing the downlink full channel information matrix #1, the downlink full channel information matrix #2, and the downlink full channel information matrix #3 by the BS, refer to step S324, and details are not described herein again.

According to the technical solution of the foregoing embodiment, first, in this embodiment, the UE only needs to send uplink channel pilot signals whose quantity is equal to the quantity of antenna ports (which may be simply one port) of the UE to the BS, so that the BS estimates common path domain parameters that occupy most channel resource overheads in a reflection channel and a direct channel.

Next, in this embodiment, the BS may use a common path domain parameter of each channel as a reference, and send downlink channel pilot information whose quantity is significantly less than the quantity of antennas of the BS, without considering the quantity of antenna ports of the BS. This can greatly reduce downlink pilot overheads.

Further, in this embodiment, the UE needs to feed back only downlink channel path domain parameters that are of the reflection channel and the direct channel and that occupy a small part of channel overheads to the BS, and a quantity of uplink feedbacks is reduced.

Finally, in this embodiment, the downlink full channel information matrix is reconstructed based on specific parameters of the reflection channel and the direct channel before aliasing, so that accuracy of channel estimation can be improved.

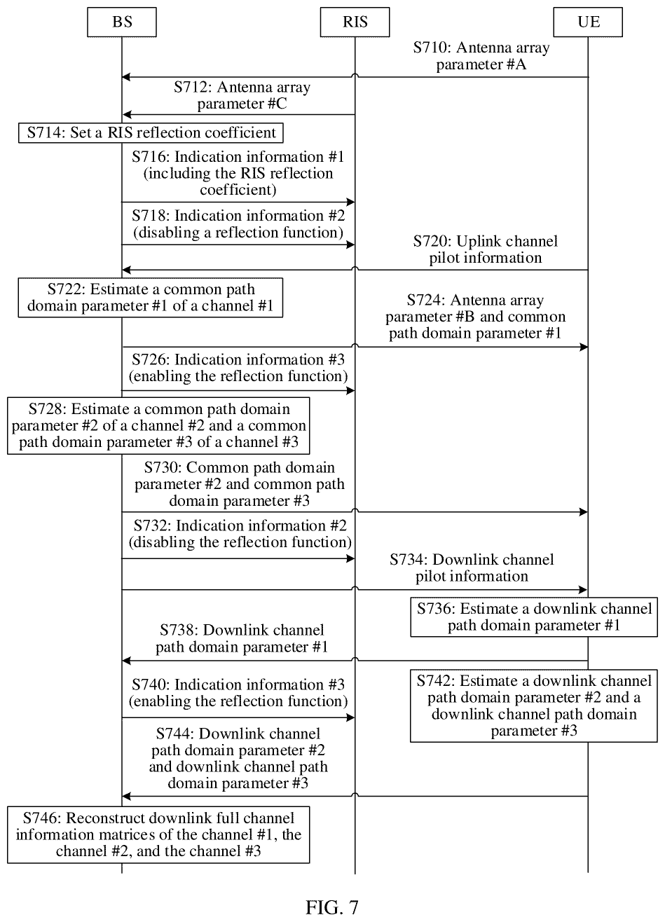

The common path domain parameter #1, the common path domain parameter #2, and the common path domain parameter #3 in embodiment provided above are coupled together for estimation by the BS, and the downlink channel path domain parameter #1, the downlink channel path domain parameter #2, and the downlink channel path domain parameter #3 are coupled together for estimation by the UE side. This application provides an embodiment in which the common path domain parameters of the reflection channel and the direct channel and the downlink channel path domain parameters are decoupled for independent estimation, as shown in FIG. 7.

For step S710 to step S716, refer to step S510 to step S516. Details are not described herein again.

Step S718: A BS sends indication information #2 to a RIS array, where the indication information #2 indicates the RIS to disable a reflection function.

Step S720: UE sends uplink channel pilot information to the BS at a plurality of moments t1 to tn of a symbol granularity. The BS receives, at the plurality of moments t1 to tn of the symbol granularity, the uplink channel pilot information sent by the UE.

Specifically, the uplink channel pilot information is not only directly sent to the BS through a channel #1, but also sent to the BS through a channel #2, reflected by the RIS array, and then sent to the BS through a channel #3.

Step S722: The BS estimates a common path domain parameter #1 of the channel #1 based on an antenna array parameter #B, an antenna array parameter #A, and uplink channel pilot receiving information.

Specifically, the common path domain parameter #1 includes parameters such as \hat{φ}_{bs}, \hat{φ}ᵤₑ, \hat{ν} and \hat{p}.

Specifically, a method for estimating the common path domain parameter #1 by the BS is similar to that in step S314, and details are not described herein again.

Step S724: The BS sends the estimated common path domain parameter #1 of the direct channel to the UE.

Optionally, the BS also sends the antenna array parameter #B to the UE.

Step S726: The BS sends indication information #3 to the RIS array, where the indication information #3 indicates the RIS array to enable the reflection function.

Step S728: The BS estimates a common path domain parameter #2 of the channel #2 and a common path domain parameter #3 of the channel #3 based on an antenna array parameter #C and the common path domain parameter #1 of the channel #1.

Optionally, the BS may further estimate the common path domain parameter #2 of the channel #2 and the common path domain parameter #3 of the channel #3 with reference to the antenna array parameter #A. In this way, the obtained common path domain parameter is more accurate.

Specifically, the common path domain parameter #2 of the channel #2 includes parameters such as \hat{φ}_{bs}, \hat{φ}ᵣᵢₛ, \hat{ν} and \hat{p}, and the common path domain parameter #3 of the channel #3 includes parameters such as \hat{φ}_{bs}, \hat{φ}ᵤₑ, \hat{ν} and \hat{p}.

A method for estimating the common path domain parameter #1, the common path domain parameter #2, and the common path domain parameter #3 of the channel #1, the channel #2, and the channel #3 by the BS is similar to that in step S314, and details are not described herein again.

Step S730: The BS sends the estimated common path domain parameter #2 of the channel #2 and the estimated common path domain parameter #3 of the channel #3 to the UE.

Step S732: The BS sends indication information #2 to the RIS array, where the indication information #2 indicates the RIS array to disable the reflection function.

Step S734: The BS sparsely sends downlink channel pilot information to the UE in a space domain dimension.

Specifically, the downlink channel pilot information may be a CSIP-RS. The CSIP-RS is a new type of time-frequency sparse pilot whose code length is far less than a quantity of antennas or a quantity of antenna ports of the BS for transmission and whose time domain period exceeds channel coherence time.

A method for constructing a pilot codebook of the CSI-HP-RS pilot information is described above, and details are not described herein again.

Specifically, an order of magnitude of the downlink channel pilot information sent by the BS is significantly less than the quantity of antenna ports of the BS. The BS does not need to send downlink pilot information whose quantity is equal to a quantity of antennas or logical ports of the BS, so that downlink pilot overheads on the BS side can be reduced.

In addition, pilot information sent by the BS for sounding of downlink specific path domain parameters may be sent at equal intervals or unequal intervals through BS array antennas. This is not limited in this application.

Step S736: The UE estimates a downlink channel path domain parameter #1 of the channel #1 based on downlink channel pilot receiving information, the common path domain parameter #1, and the antenna array parameter #A.

Specifically, the downlink channel path domain parameter #1 includes an initial phase.

Specifically, by way of example, and not limitation, estimation methods used by the UE to estimate the downlink channel path domain parameter #1 include methods such as MLE, MAP, and SBL that are based on the Bayesian criterion. For the estimation methods, refer to step S320. Details are not described herein again.

Step S738: The UE sends the estimated downlink channel path domain parameter #1 to the BS.

Step S740: The BS sends indication information #3 to the RIS array, where the indication information #3 indicates the RIS array to enable the reflection function.

Step S742: The UE estimates a downlink channel path domain parameter #2 of the channel #2 and a downlink channel path domain parameter #3 of the channel #3 based on the downlink channel pilot information, the downlink channel path domain parameter #1, the antenna array parameter #A, and the antenna array parameter #C.

Optionally, the UE may estimate a more accurate downlink channel path domain parameter #2 and a more accurate downlink channel path domain parameter #3 with reference to the obtained common path domain parameter #1, common path domain parameter #2, and common path domain parameter #3.

Optionally, the downlink channel path domain parameter #2 and the downlink channel path domain parameter #3 that are estimated by the UE with reference to the antenna array parameter #B are more accurate.

Specifically, the downlink channel path domain parameter #2 and the downlink channel path domain parameter #3 include initial phases of the channel #2 and the channel #3.

Specifically, by way of example, and not limitation, estimation methods used by the UE to estimate the downlink channel path domain parameter #2 and the downlink channel path domain parameter #3 include methods such as MLE, MAP, and SBL that are based on the Bayesian criterion. For the estimation methods, refer to step S320. Details are not described herein again.

Step S744: The UE sends the estimated downlink channel path domain parameter #2 and downlink channel path domain parameter #3 to the BS.

Step S746: The BS reconstructs a downlink full channel information matrix #1 of the channel #1, a downlink full channel information matrix #2 of the channel #2, and a downlink full channel information matrix #3 of the channel #3 respectively based on the common path domain parameter #1 and the downlink channel path domain parameter #1 of the channel #1, the common path domain parameter #2 and the downlink channel path domain parameter #2 of the channel #2, and the common path domain parameter #3 and the downlink channel path domain parameter #3 of the channel #3 obtained above.

Specifically, for a method for constructing the downlink full channel information matrix #1, the downlink full channel information matrix #2, and the downlink full channel information matrix #3 by the BS, refer to step S324, and details are not described herein again.

According to the technical solution of the foregoing embodiment, first, in this embodiment, the UE only needs to send uplink pilot signals whose quantity is equal to a quantity of antenna ports (which may be simply one port) of the UE to the BS, so that the BS respectively estimates common path domain parameters that occupy most channel overhead resources in a reflection channel and a direct channel.

Next, in this embodiment, the BS may use a common path domain parameter of each channel as a reference, and send downlink channel pilot information whose quantity is significantly less than the quantity of antennas of the BS, without considering the quantity of antenna ports of the BS. This can greatly reduce downlink pilot overheads.

Further, in this embodiment, the UE needs to feed back only downlink channel path domain parameters that are of the reflection channel and the direct channel and that occupy a small part of channel overheads to the BS, and a quantity of uplink feedbacks is reduced.

Finally, the BS in this embodiment may indicate enabling and disabling of the RIS reflection function, so that sounding of the common path domain parameter of the channel and sounding of the downlink channel path domain parameter can be decoupled, thereby improving accuracy of channel sounding.

It should be noted that, a value of each step number in each of the foregoing embodiments cannot limit an implementation sequence of each step, and when necessary, the implementation sequence of each step may be adjusted to some extent based on an implementation objective.

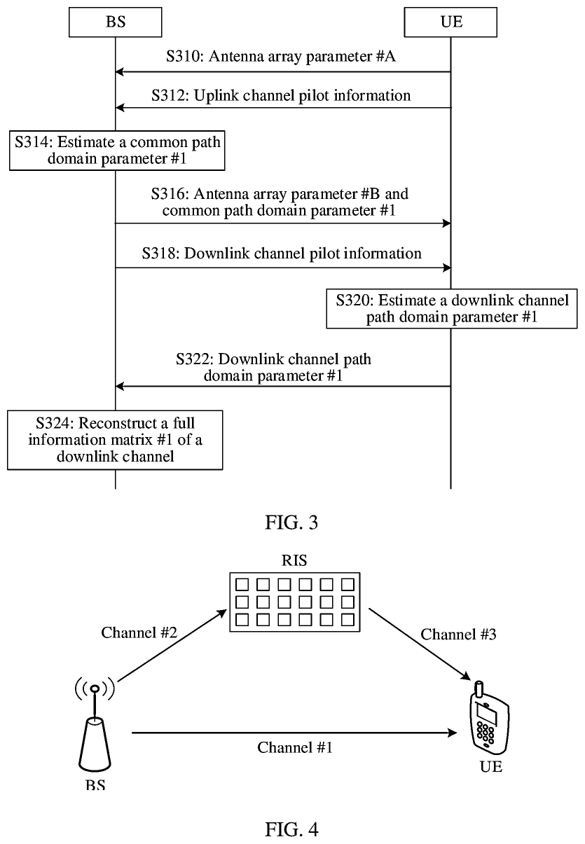

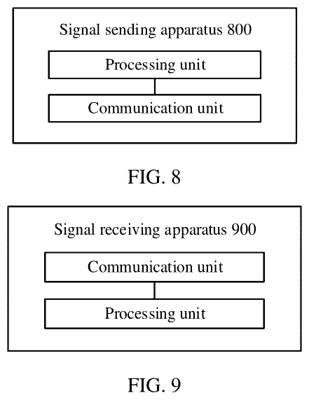

According to the foregoing method, FIG. 8 is a block diagram of a signal sending communication apparatus 800 according to an embodiment of this application. The communication apparatus 800 may correspond to (for example, may be configured on or may be) the RS, the RIS array, or the UE described in the methods in FIG. 2, FIG. 3, FIG. 5, FIG. 6, and FIG. 7. In addition, modules or units in the signal sending communication apparatus 800 are respectively configured to perform actions or processing processes performed by the RS, the RIS array, or the UE in the methods in FIG. 2, FIG. 3, FIG. 5, FIG. 6, and FIG. 7. To avoid repetition, detailed descriptions thereof are omitted herein.

In this embodiment of this application, the apparatus 800 may be the RS, the RIS array, or the UE. In this case, the apparatus 800 may include a processor and a transceiver. The processor and the transceiver are communicatively connected. Optionally, the apparatus further includes a memory, and the memory is communicatively connected to the processor. Optionally, the processor, the memory, and the transceiver may be communicatively connected to each other. The memory may be configured to store instructions. The processor is configured to execute the instructions stored in the memory, to control the transceiver to send information or a signal.

In this case, a communication unit in the apparatus 800 shown in FIG. 8 may correspond to the transceiver, and a processing unit in the apparatus 800 shown in FIG. 8 may correspond to the processor.

In this embodiment of this application, the apparatus 800 may be a chip (or a chip system) installed in the RS, the RIS array, or the UE. In this case, the apparatus 800 may include a processor and an input/output interface. The processor may be communicatively connected to a transceiver of the RS, the RIS array, or the UE through the input/output interface. Optionally, the apparatus further includes a memory, and the memory and the processor are communicatively connected. Optionally, the processor, the memory, and the transceiver may be communicatively connected to each other. The memory may be configured to store instructions. The processor is configured to execute the instructions stored in the memory, to control the transceiver to send information or a signal.

In this case, the communication unit in the apparatus 800 shown in FIG. 8 may correspond to the input/output interface, and the processing unit in the apparatus 800 shown in FIG. 8 may correspond to the processor.

FIG. 9 is a block diagram of a signal receiving apparatus 900 according to an embodiment of this application. The signal receiving apparatus 900 may correspond to (for example, may be configured to implement) the RS, the RIS array, or the UE described in the methods in FIG. 2, FIG. 3, FIG. 5, FIG. 6, and FIG. 7. Modules or units in the signal receiving apparatus 900 are respectively configured to perform actions or processing processes performed by the RS, the RIS array, or the UE in the methods in FIG. 2, FIG. 3, FIG. 5, FIG. 6, and FIG. 7. To avoid repetition, detailed descriptions thereof are omitted herein.

In this embodiment of this application, the apparatus 900 may be the RS, the RIS array, or the UE. In this case, the apparatus 900 may include a processor and a transceiver. The processor and the transceiver are communicatively connected. Optionally, the apparatus further includes a memory, and the memory is communicatively connected to the processor. Optionally, the processor, the memory, and the transceiver may be communicatively connected to each other. The memory may be configured to store instructions. The processor is configured to execute the instructions stored in the memory, to control the transceiver to receive information or a signal.

In this case, a communication unit in the apparatus 900 shown in FIG. 9 may correspond to the transceiver, and a processing unit in the apparatus 900 shown in FIG. 9 may correspond to the processor.

In this embodiment of this application, the apparatus 900 may be a chip (or a chip system) installed in the RS, the RIS array, or the UE. In this case, the apparatus 900 may include a processor and an input/output interface. The processor may be communicatively connected to a transceiver of a network device through the input/output interface. Optionally, the apparatus further includes a memory, and the memory and the processor are communicatively connected. Optionally, the processor, the memory, and the transceiver may be communicatively connected to each other. The memory may be configured to store instructions. The processor is configured to execute the instructions stored in the memory, to control the transceiver to receive information or a signal.

In this case, the communication unit in the apparatus 900 shown in FIG. 9 may correspond to the input/output interface, and the processing unit in the apparatus 900 shown in FIG. 9 may correspond to the processor.

A person of ordinary skill in the art may be aware that, in combination with the examples described in embodiments disclosed in this specification, units and algorithm steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this application.

It may be clearly understood by a person skilled in the art that, for the purpose of convenient and brief description, for a detailed working process of the foregoing system, apparatus, and unit, refer to a corresponding process in the foregoing method embodiments. Details are not described herein again.

In several embodiments provided in this application, it should be understood that the disclosed system, apparatus, and method may be implemented in other manners. For example, the described apparatus embodiment is merely an example. For example, division into the units is merely logical function division and may be other division during actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of embodiments.

In addition, functional units in embodiments of this application may be integrated into one processing unit, each of the units may exist alone physically, or two or more units are integrated into one unit.

When the functions are implemented in the form of a software functional unit and sold or used as an independent product, the functions may be stored in a computer-readable storage medium. Based on such an understanding, the technical solutions of this application essentially, or the part contributing to the prior art, or some of the technical solutions may be implemented in a form of a software product. The computer software product is stored in a storage medium, and includes several instructions for instructing a computer device (which may be a personal computer, a server, or a network device) to perform all or some of the steps of the methods described in embodiments of this application. The foregoing storage medium includes any medium that can store program code, such as a USB flash drive, a removable hard disk, a read-only memory (Read-Only Memory, ROM), a random access memory (Random Access Memory, RAM), a magnetic disk, or an optical disc.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. A communication method, applicable for a terminal device, wherein the method comprises:
obtaining first indication information, and obtaining downlink channel information, wherein the first indication information indicates a first path domain parameter, the first path domain parameter is a path domain parameter shared by a first uplink channel and a first downlink channel, the first uplink channel and the first downlink channel are channels for communication between a network device and the terminal device, the downlink channel information is sent through M antenna ports in N antenna ports of the network device, M is less than N, M is greater than or equal to 1, and both M and N are positive integers;
estimating a second path domain parameter based on the first path domain parameter and the downlink channel information; and
sending second indication information, wherein the second indication information indicates the second path domain parameter, and the first path domain parameter and the second path domain parameter are used for channel reconstruction of the first downlink channel.

2. The method according to claim 1, wherein the first path domain parameter comprises at least one of the following:
a power coefficient, a direction angle, or a Doppler factor that are of the first uplink channel.

3. The method according to claim 1, wherein the second path domain parameter comprises an initial phase of the first downlink channel.

4. The method according to claim 1, wherein before the obtaining first indication information, the method further comprises:
sending uplink channel information, wherein the first indication information is determined based on the uplink channel information.

5. The method according to claim 1, wherein the method further comprises:
sending, by the terminal device, first parameter information, wherein the first parameter information indicates a parameter of an antenna array of the terminal device, the first indication information is generated based on uplink channel information sent by the terminal device to the network device, the first parameter information, and second parameter information, and the second parameter information indicates a parameter of an antenna array of the network device.

6. The method according to claim 1, wherein before the estimating a second path domain parameter based on the first path domain parameter and the downlink channel information, the method further comprises:
obtaining the second parameter information; and
estimating the second path domain parameter based on the first path domain parameter, the downlink channel information, the first parameter information, and the second parameter information.

7. The method according to claim 1, wherein the first indication information further indicates the first path domain parameter, a third path domain parameter, and a fifth path domain parameter, the third path domain parameter is a path domain parameter shared by a second uplink channel and a second downlink channel, the second uplink channel and the second downlink channel are channels for communication between the network device and the RIS array, the fifth path domain parameter is a path domain parameter shared by a third uplink channel and a third downlink channel, and the third uplink channel and the third downlink channel are channels for communication between the RIS array and the terminal device; and/or,
wherein the second indication information further indicates the second path domain parameter, a fourth path domain parameter, and a sixth path domain parameter, the fourth path domain parameter is determined by the terminal device based on the third path domain parameter and the downlink channel information, and the sixth path domain parameter is determined by the terminal device based on the fifth path domain parameter and the downlink channel information.

8. A communication method, applicable for a network device, wherein the method comprises:
obtaining uplink channel information;
estimating a first path domain parameter based on the uplink channel information, wherein the first path domain parameter is a path domain parameter shared by a first uplink channel and a first downlink channel, and the first uplink channel and the first downlink channel are channels for communication between the network device and a terminal device;
sending first indication information, and sending downlink channel information through M antenna ports in N antenna ports of the network device, wherein the first indication information indicates the first path domain parameter, M is less than N, M is greater than or equal to 1, and both M and N are positive integers;
obtaining second indication information, wherein the second indication information indicates a second path domain parameter, and the second path domain parameter is determined based on the first path domain parameter and the downlink channel information; and
performing channel reconstruction on the first downlink channel based on the first path domain parameter and the second path domain parameter.

9. The method according to claim 8, wherein the estimating a first path domain parameter based on the uplink channel information further comprises:
obtaining first parameter information, wherein the first parameter information indicates a parameter of an antenna array of the terminal device; and
estimating the first path domain parameter based on the uplink channel information, second parameter information, and the first parameter information, wherein the second parameter information indicates a parameter of an antenna array of the network device.

10. The method according to claim 8, wherein the method further comprises:
obtaining third parameter information, wherein the third parameter information indicates an antenna array parameter of a reconfigurable intelligent surface RIS array; and
sending third indication information based on the third parameter information, wherein the third indication information indicates a reflection coefficient of the RIS array, and the RIS array is used to reflect a signal between the network device and the terminal device.

11. A communication apparatus, comprising a processor coupled to a memory storing instructions, which when executed by the processor, cause the apparatus to:
obtain first indication information, and obtaining downlink channel information, wherein the first indication information indicates a first path domain parameter, the first path domain parameter is a path domain parameter shared by a first uplink channel and a first downlink channel, the first uplink channel and the first downlink channel are channels for communication between a network device and the communication apparatus, the downlink channel information is sent through M antenna ports in N antenna ports of the network device, M is less than N, M is greater than or equal to 1, and both M and N are positive integers;
estimate a second path domain parameter based on the first path domain parameter and the downlink channel information; and
send second indication information, wherein the second indication information indicates the second path domain parameter, and the first path domain parameter and the second path domain parameter are used for channel reconstruction of the first downlink channel.

12. The communication apparatus according to claim 11, wherein the first path domain parameter comprises at least one of the following:
a power coefficient, a direction angle, or a Doppler factor that are of the first uplink channel.

13. The communication apparatus according to claim 11, wherein the second path domain parameter comprises an initial phase of the first downlink channel.

14. The communication apparatus according to claim 11, wherein when the instructions are executed by the processor, further cause the apparatus to:
send, before the obtaining first indication information, uplink channel information, wherein the first indication information is determined based on the uplink channel information.

15. The communication apparatus according to claim 11, wherein when the instructions are executed by the processor, further cause the apparatus to:
send first parameter information, wherein the first parameter information indicates a parameter of an antenna array of the communication apparatus, the first indication information is generated based on uplink channel information sent by the communication apparatus to the network device, the first parameter information, and second parameter information, and the second parameter information indicates a parameter of an antenna array of the network device.

16. The communication apparatus according to claim 11, wherein when the instructions are executed by the processor, further cause the apparatus to:
wherein the communication apparatus further comprises:
obtain, before the estimating a second path domain parameter based on the first path domain parameter and the downlink channel information, the second parameter information; and
estimate the second path domain parameter based on the first path domain parameter, the downlink channel information, the first parameter information, and the second parameter information.

17. The communication apparatus according to claim 11, wherein the first indication information further indicates the first path domain parameter, a third path domain parameter, and a fifth path domain parameter, the third path domain parameter is a path domain parameter shared by a second uplink channel and a second downlink channel, the second uplink channel and the second downlink channel are channels for communication between the network device and the RIS array, the fifth path domain parameter is a path domain parameter shared by a third uplink channel and a third downlink channel, and the third uplink channel and the third downlink channel are channels for communication between the RIS array and the communication apparatus; and/or,
wherein the second indication information further indicates the second path domain parameter, a fourth path domain parameter, and a sixth path domain parameter, the fourth path domain parameter is determined by the communication apparatus based on the third path domain parameter and the downlink channel information, and the sixth path domain parameter is determined by the communication apparatus based on the fifth path domain parameter and the downlink channel information.

18. A communication apparatus, comprising a processor coupled to a memory storing instructions, which when executed by the processor, cause the apparatus to:
obtain uplink channel information;
estimate a first path domain parameter based on the uplink channel information, wherein the first path domain parameter is a path domain parameter shared by a first uplink channel and a first downlink channel, and the first uplink channel and the first downlink channel are channels for communication between the communication apparatus and a terminal device;
send first indication information, and sending downlink channel information through M antenna ports in N antenna ports of the communication apparatus, wherein the first indication information indicates the first path domain parameter, M is less than N, M is greater than or equal to 1, and both M and N are positive integers;
obtain second indication information, wherein the second indication information indicates a second path domain parameter, and the second path domain parameter is determined based on the first path domain parameter and the downlink channel information; and
perform channel reconstruction on the first downlink channel based on the first path domain parameter and the second path domain parameter.

19. The communication apparatus according to claim 18, wherein when the instructions are executed by the processor, specifically cause the apparatus to:
obtain first parameter information, wherein the first parameter information indicates a parameter of an antenna array of the terminal device; and
estimate the first path domain parameter based on the uplink channel information, second parameter information, and the first parameter information, wherein the second parameter information indicates a parameter of an antenna array of the communication apparatus.

20. The communication apparatus according to claim 18, wherein when the instructions are executed by the processor, further cause the apparatus to:
obtaining third parameter information, wherein the third parameter information indicates an antenna array parameter of a reconfigurable intelligent surface RIS array; and
sending third indication information based on the third parameter information, wherein the third indication information indicates a reflection coefficient of the RIS array, and the RIS array is used to reflect a signal between the communication apparatus and the terminal device.
